(19) United States
(12) Patent Application Publication
(10) Pub. No.: US 2025/0293738 A1
(43) Pub. Date: Sep. 18, 2025

(54) BEAM PAIRING PREDICTION WITH ASSISTANCE INFORMATION

(71) Applicant: Telefonaktiebolaget LM Ericsson (PUBL), Stockholm (SE)

(72) Inventors: Jingya LI, GÖTEBORG (SE); Xinlin Zhang, GÖTEBORG (SE); Henrik Rydén, STOCKHOLM (SE); Chunhui LI, Yokohama Kanagawa (JP); Yufei Blankenship, KILDEER, IL (US); Johan Winges, MÖLNDAL (SE); Icaro Leonardo Da Silva, SOLNA (SE)

(21) Appl. No.: 18/859,658

(22) PCT Filed: Apr. 26, 2023
(86) PCT No.: PCT/SE2023/050386

§ 371 Date: Oct. 24, 2024

Related U.S. Application Data
(60) Provisional application No. 63/335,851, filed on Apr. 28, 2022.

(51) Int. Cl. H04B 7/06; H04W 74/0833

(52) U.S. Cl. CPC H04B 7/0617; H04W 74/0833

(57) ABSTRACT

A method (1900) by a first radio node (205, 210) includes receiving (1902), from a second radio node (205, 210), beamforming information comprising at least one parameter related to at least one spatial property of at least one reference signal beam. In particular, the beamforming information related to the at least one spatial property may include at least one of a beam configuration, a spatial correlation between two or more reference signal beams, and/or a capability related to beamforming at the second radio node.

### TECHNICAL FIELD

The present disclosure relates, in general, to wireless communications and, more particularly, systems and methods for beam pairing prediction with assistance information.

### BACKGROUND

One of the key features of New Radio (NR), compared to previous generation of wireless networks, is the ability to operate in higher frequencies (e.g., above 10 GHz). The available large transmission bandwidths in these frequency ranges can potentially provide large data rates. However, as carrier frequency increases, both pathloss and penetration loss increase. To maintain the coverage at the same level, highly directional beams are required to focus the radio transmitter energy in a particular direction on the receiver. However, large radio antenna arrays—at both receiver and transmitter sides—are needed to create such highly direction beams.

To reduce hardware costs, large antenna arrays for high frequencies use time-domain analog beamforming. The core idea of analog beamforming is to share a single radio frequency chain between many (or, potentially, all) of the antenna elements. A limitation of analog beamforming is that it is only possible to transmit radio energy in using one beam (in one direction) at a given time.

The above limitation requires the network and user equipment (UE) to preform beam management procedures to establish and maintain suitable transmitter (Tx)/receiver (Rx) beam-pairs. For example, beam management procedures can be used by a transmitter to sweep a geographic area by transmitting reference signals on different candidate beams, during non-overlapping time intervals, using a predetermined pattern. By measuring the quality of the reference signals at the receiver side, the best transmitter and receiver beams can be identified.

### NR Beam Management Procedures

Beam management procedures in NR are defined by a set of Layer 1 (L1)/Layer 2 (L2) procedures that establish and maintain suitable beam pairs for both transmitting and receiving data. A beam management procedure can include the following sub procedures: beam determination, beam measurements, beam reporting, and beam sweeping.

In case of downlink (DL) transmission from the Network to the User Equipment (UE), P1/P2/P3 beam management procedures can be performed according to the NR SI technical report to overcome the challenges of establishing and maintaining the beam pairs when, for example, a UE moves or some blockage in the environment requires changing the beams. Although these scenarios are not directly mentioned in specifications, there are relevant procedures defined which enables the realization of these scenarios, examples of such realization are depicted in the corresponding figure of each scenario:
P1: The P1 procedure is used to enable UE measurement on different transmission/reception point (TRP) Tx beams to support selection of TRP Tx beams/UE Rx beam(s). For example during initial access procedure, gNodeB (gNB) transmits Synchronization Signal/Physical Broadcast Channel block (SSB) beams in different directions to cover the whole cell. Each UE measures signal quality on corresponding SSB signals to detect and select the appropriate SSB beam, as shown in FIG. 1. Random access is then transmitted on the Random Access Channel (RACH) resources indicated by the selected SSB. The corresponding beam will be used by both the UE and the network to communicate until connected mode beam management is active. The network infers which SSB beam was chosen by the UE without any explicit signalling.
   For beamforming at TRP, it typically includes an intra/inter-TRP Tx beam sweep from a set of different beams. For beamforming at UE, it typically includes a UE Rx beam sweep from a set of different beams.
P2: The P2 procedure is used to enable UE measurement on different TRP Tx beams to possibly change inter/intra-TRP Tx beam(s). The network can use the SSB beam as an indication of which (narrow) Channel State Information-Reference Signal (CSI-RS) beams to try, i.e. the candidate set of narrow CSI-RS beams for beam management is based on the best SSB beam. Once CSI-RS is transmitted, the UE measures the Reference Signal Received Power (RSRP) and reports the result to the network. If the network receives a CSI-RSRP report from the UE where a new CSI-RS beam is better than the old used to transmit Physical Downlink Control Channel (PDCCH)/Physical Downlink Shared Channel (PDSCH), the network updates the serving beam for the UE accordingly, and possibly also modifies the candidate set of CSI-RS beams. The network can also instruct the UE to perform measurements on SSBs. If the network receives a report from the UE where a new SSB beam is better than the previous best SSB beam, a corresponding update of the candidate set of CSI-RS beams for the UE may be motivated.

P2 procedure is performed on a possibly smaller set of beams for beam refinement than in P1. Note that P2 can be a special case of P1. For example, in connected mode gNB configures the UE with different CSI-RSs and transmits each CSI-RS on corresponding beam. UE then measures the quality of each CSI-RS beam on its current Rx beam and send feedback about the quality of the measured beams. Thereafter, based on this feedback, gNB will decide and possibly indicates to the UE which beam will be used in future transmissions. FIG. 2 illustrates an example P2 Procedure.
P3: The P3 Procedure is used to enable UE measurement on the same TRP Tx beam to change UE Rx beam in the case UE uses beamforming. Once in connected mode, the UE is configured with a set of reference signals. Based on measurements, the UE determines which Rx beam is suitable to receive each reference signal in the set. The network then indicates which reference signals are associated with the beam that will be used to transmit PDCCH/PDSCH, and the UE uses this information to adjust its Rx beam when receiving PDCCH/PDSCH. FIG. 3 illustrates an example P3 Procedure.
   In connected mode, P3 can be used by the UE to find the best Rx beam for corresponding Tx beam. In this case, gNB keeps one CSI-RS Tx beam at a time, and UE performs the sweeping and measurements on its own Rx beams for that specific Tx beam. UE then finds the best corresponding Rx beam based on the measurements and will use it in future for reception when gNB indicates the use of that Tx beam.

### Beam Measurement and Reporting in NR

For beam management, a UE can be configured to report RSRP or/and Signal Interference to Noise Ratio (SINR) for each one of up to four beams, either on CSI-RS or SSB. UE measurement reports can be sent either over Physical Uplink Control Channel (PUCCH) or Physical Uplink Shared Channel (PUSCH) to the network node, e.g., gNB.

### Reference Signal Configurations

A CSI-RS is transmitted over each Tx antenna port at the network node and for different antenna ports. The CSI-RS are multiplexed in time, frequency, and code domain such that the channel between each Tx antenna port at the network node and each receive antenna port at a UE can be measured by the UE. The time-frequency resource used for transmitting CSI-RS is referred to as a CSI-RS resource.

In NR, the CSI-RS for beam management is defined as a 1-or 2-port CSI-RS resource in a CSI-RS resource set where the filed repetition is present. The following three types of CSI-RS transmissions are supported:
Periodic CSI-RS: CSI-RS is transmitted periodically in certain slots. This CSI-RS transmission is semi-statically configured using Radio Resource Control (RRC) signaling with parameters such as CSI-RS resource, periodicity, and slot offset.
Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling is needed to activate and deactivate the CSI-RS transmission.
Aperiodic CSI-RS: This is a one-shot CSI-RS transmission that can happen in any slot. Here, one-shot means that CSI-RS transmission only happens once per trigger. The CSI-RS resources (i.e., the Reference Element (RE) locations that consist of subcarrier locations and Orthogonal Frequency Domain Multiplexing (OFDM) symbol locations) for aperiodic CSI-RS are semi-statically configured. The transmission of aperiodic CSI-RS is triggered by dynamic signaling through PDCCH using the CSI request field in uplink (UL) Downlink Control Information (DCI), in the same DCI where the UL resources for the measurement report are scheduled. Multiple aperiodic CSI-RS resources can be included in a CSI-RS resource set and the triggering of aperiodic CSI-RS is on a resource set basis.

### SSB:

In NR, an SSB consists of a pair of synchronization signals (SSs), physical broadcast channel (PBCH), and Demodulation Reference Signal (DMRS) for PBCH. A SSB is mapped to 4 consecutive OFDM symbols in the time domain and 240 contiguous subcarriers (20 Resource Blocks (RBs)) in the frequency domain.

To support beamforming and beam-sweeping for SSB transmission, in NR, a cell can transmit multiple SSBs in different narrow-beams in a time multiplexed fashion. The transmission of these SSBs is confined to a half frame time interval (5 ms). It is also possible to configure a cell to transmit multiple SSBs in a single wide-beam with multiple repetitions. The design of beamforming parameters for each of the SSBs within a half frame is up to network implementation. The SSBs within a half frame are broadcasted periodically from each cell. The periodicity of the half frames with SS/PBCH blocks is referred to as SSB periodicity, which is indicated by SIB1.

The maximum number of SSBs within a half frame, denoted by L, depends on the frequency band, and the time locations for these L candidate SSBs within a half frame depends on the SCS of the SSBs. The L candidate SSBs within a half frame are indexed in an ascending order in time from 0 to L−1. By successfully detecting PBCH and its associated DMRS, a UE knows the SSB index. A cell does not necessarily transmit SS/PBCH blocks in all L candidate locations in a half frame, and the resource of the un-used candidate positions can be used for the transmission of data or control signaling instead. It is up to network implementation to decide which candidate time locations to select for SSB transmission within a half frame, and which beam to use for each SSB transmission.

### Measurement Resource Configurations

In NR, a UE can be configured with N≥1 CSI reporting settings (i.e. CSI-ReportConfig), M≥1 resource settings (i.e. CSI-ResourceConfig), where each CSI reporting setting is linked to one or more resource setting for channel and/or interference measurement. The CSI framework is modular. This means that several CSI reporting settings may be associated with the same Resource Setting.

The measurement resource configurations for beam management are provided to the UE by RRC Information Elements (IEs) CSI-ResourceConfigs. One CSI-ResourceConfig contains several NZP-CSI-RS-ResourceSets and/or CSI-SSB-ResourceSets.

A UE can be configured to perform measurement on CSI-RSs. Here the RRC IE NZP-CSI-RS-ResourceSet is used. A NZP CSI-RS resource set contains the configuration of Ks≥1 CSI-RS resources, where the configuration of each CSI-RS resource includes at least: mapping to REs, the number of antenna ports, time-domain behavior, etc. Up to 64 CSI-RS resources can be grouped to a NZP-CSI-RS-ResourceSet. A UE can also be configured to perform measurements on SSBs. Here, the RRC IE CSI-SSB-ResourceSet is used. Resource sets comprising SSB resources are defined in a similar manner.

In the case of aperiodic CSI-RS and/or aperiodic CSI reporting, the network node configures the UE with S_{c} CSI triggering states. Each triggering state contains the aperiodic CSI report setting to be triggered along with the associated aperiodic CSI-RS resource sets.

Periodic and semi-persistent Resource Settings can only comprise a single resource set (i.e. S=1) while S>=1 for aperiodic Resource Settings. This is because in the aperiodic case, one out of the S resource sets comprised in the Resource Setting is indicated by the aperiodic triggering state that triggers a CSI report.

### Measurement Reporting

Three types of CSI reporting are supported in NR as follows:
Periodic CSI Reporting on PUCCH: CSI is reported periodically by a UE. Parameters such as periodicity and slot offset are configured semi-statically by higher layer RRC signaling from the network node to the UE.
Semi-Persistent CSI Reporting on PUSCH or PUCCH: Similar to periodic CSI reporting, semi-persistent CSI reporting has a periodicity and slot offset that may be semi-statically configured. However, a dynamic trigger from network node to UE may be needed to allow the UE to begin semi-persistent CSI reporting. A dynamic trigger from network node to UE is needed to request the UE to stop the semi-persistent CSI reporting.
Aperiodic CSI Reporting on PUSCH: This type of CSI reporting involves a single-shot (i.e., one time) CSI report by a UE. The single-shot CSI report is dynamically triggered by the network node using DCI. Some of the parameters related to the configuration of the aperiodic CSI report is semi-statically configured by RRC, but the triggering is dynamic.

In each CSI reporting setting, the content and time-domain behavior of the report is defined, along with the linkage to the associated Resource Settings. The CSI-ReportConfig IE comprise the following configurations:
reportConfigType
   Defines the time-domain behavior, i.e. periodic CSI reporting, semi-persistent CSI reporting, or aperiodic CSI reporting, along with the periodicity and slot offset of the report for periodic CSI reporting.
reportQuantity
   Defines the reported CSI parameter(s) (i.e., the CSI content), such as Precoder Matrix Indicator (PMI), Channel Quality Indicator (CQI), Rank Indicator (RI), LI (layer indicator), CSI-RS resource index (CRI) and L1-RSRP. Only a certain number of combinations are possible (e.g., ‘cri-RI-PMI-CQI’ is one possible value and ‘cri-RSRP’ is another), and each value of reportQuantity could be said to correspond to a certain CSI mode.
codebookConfig
   Defines the codebook used for PMI reporting, along with possible codebook subset restriction (CBSR). Two “Types” of PMI codebook are defined in NR, Type I CSI and Type II CSI, each codebook type further has two variants each.
reportFrequencyConfiguration
   Define the frequency granularity of PMI and CQI (wideband or subband), if reported, along with the CSI reporting band, which is a subset of subbands of the bandwidth part (BWP) which the CSI corresponds to
Measurement restriction in time domain (ON/OFF) for channel and interference respectively

For beam management, a UE can be configured to report L1-RSRP for up to four different CSI-RS/SSB resource indicators. The reported RSRP value corresponding to the first (best) CRI/SSBRI requires 7 bits, using absolute values, while the others require 4 bits using encoding relative to the first. In NR Release 16, the report of LI-SINR for beam management has already been supported.

There currently exist certain challenge(s), however. For example, identifying a suitable beam pair between a gNB and a UE for transmitting and receiving data is challenging, especially when the number of beam pairs is large. The task also requires a common understanding between the UE and the radio network (e.g. gNodeB) concerning which pair is being used (so that when the UE transmits using a certain beam pair, the network is also listening on the certain beam pair).

As described above, the RS used for P1/P2/P3 based beam management can be SSB and/or CSI-RS. At mmWave carrier frequency, NR supports up to 64 SSB transmitted in different spatial directions/beams at a gNB. The CSI-RS beams can be narrower than the SSB beams, and the number of CSI-RS beams transmitted from a gNB can be larger than 64. If a gNB has 64 Tx beams and a UE has 8 Rx beams, then, there are in total 512 beam pairs that needs to be evaluated to identify the optimal beam pair. This can result in:
significant network signaling overhead for the gNB to configure the beam measurements and to transmit the RSs to enable UE to perform beam measurements (e.g. RSRP per beam pair), thereby, consuming DL radio resources;
significant beam measurement reporting from the UE, which consumes UL radio resources and UE processing power; and/or.
large latency that is needed for the gNB to transmit all the RS beams and for the UE to perform measurements of all beam pairs and reporting them to the gNB.

To reduce the overhead and latency, it is possible for the network to configure the UE to perform measurements on only a subset of DL RS beams. However, if this subset of DL RS beams is not selected carefully, there is a risk that the UE/gNB cannot identify a suitable beam pair even though one exists. This can lead to increased overhead and latency, e.g., by configuring the UE to measure and report another subset of DL RS beam, or unnecessary beam switches/beam failures/connection drops, if the gNB relied only on this subset RS based measurements.

Another possible solution is to predict the quality of all beam pairs using the measurements of the subset of beam pairs. This prediction can be done either at the gNB (the transmitter node) or at the UE (the receiver node). However, based on current NR specification, the gNB has very limited information about the Rx beam configuration at the UE. For example, the gNB may not know how many Rx beams the UE has used when performing P1/P2/P3 measurements. As another example, the gNB may not know which Rx beam is selected and used by the UE for reception after it is performing P3 procedure. Similarly, the UE may have limited information about the Tx beam configuration at the gNB. For example, the UE may only know which RS resources (SSB indexes or CSI-RS ports) it should measure and report when performing P2 procedure. These make it very difficult for a network or a UE to perform good prediction for all beam pairs using only measurements from a subset of beam pairs. This is especially challenging if these predictions are to be performed based on Machine Learning (ML)-model which have been trained at a different period of time wherein the configuration of these Tx and Rx beams may have changed.

FIGS. 4A-C illustrates the problem of performing SSB-based beam-pair prediction at the UE with limited info about the Tx beam configurated for SSB transmissions at the gNB. More specifically, FIG. 4A-C illustrate examples of different beam configurations for transiting 8 SSBs per SSB priority.

As can be seen from FIG. 4A-C, even though in all the three examples, there are 8 SSB transmissions on the same set of SSB resources per SSB periodicity, the beams used for transmitting each of these 8 SSBs are different.

### SUMMARY

Certain aspects of the disclosure and their embodiments may provide solutions to these or other challenges. For example, methods and systems are provided for signaling and/or reporting that includes a first node providing beam-related information to a second node. The beam-related information is used by the second node to perform prediction of the quality of beam pairs between itself and the first node.

According to certain embodiments, a method by a first radio node includes receiving, from a second radio node, beamforming information that includes at least one parameter related to at least one spatial property of at least one reference signal beam.

According to certain embodiments, a first radio node is adapted to receive, from a second radio node, beamforming information that includes at least one parameter related to at least one spatial property of at least one reference signal beam.

According to certain embodiments, a method by a second radio node includes transmitting, to a first radio node, beamforming information comprising at least one parameter related to at least one spatial property of at least one reference signal beam.

According to certain embodiments, a second radio node is adapted to transmit, to a first radio node, beamforming information comprising at least one parameter related to at least one spatial property of at least one reference signal beam.

Certain embodiments may provide one or more of the following technical advantage(s). For example, certain embodiments may provide a technical advantage of enabling a Tx node (e.g., gNB) or a Rx node (e.g., UE) to receive assistance information about beam-related information (e.g., antenna configurations, spatial correlations between different Rx beams, and/or beamforming capabilities) of a Rx node (e.g., a UE) or a Tx node (e.g., a gNB), thereby, performing better predictions for beam paring between the Tx node and the Rx node, using beam measurements on only a subset of beam pairs. This can lead to reduced signaling, reporting overhead, and latency for beam pairing. For the UE, obtaining this beam-related information may enable the detection of the need for re-training an ML-model for beam pairing prediction, in case the ML-model at the UE is trained based on outdated beam-related information (e.g. Tx beam configurations) which has been modified.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates SSB beam selection as part of an initial access procedure according to the P1 Procedure scenario;

FIG. 2 illustrates CSI-RS Tx beam selection in DL according to the P2 Procedure scenario;

FIG. 3 illustrates UE Rx beam selection for corresponding CSI-RS Tx beam in DL, according to the P3 Procedure scenario;

FIGS. 4A-4C illustrate examples of different beam configurations for transmitting 8 SSBs per SSB priority;

FIG. 5 illustrates example construction of a message that consists of multiple beam spatial-Info parameters for multiple RS beams, according to certain embodiments;

FIGS. 6A-6C illustrates an example beam configuration for indicating the beam spatial-Info parameters of all RS resource indexes to the Rx node, according to certain embodiments;

FIG. 7 illustrates an example beam configuration for indicating the beam spatial-Info parameters of configured RS resource indexes to the Rx node, according to certain embodiments;

FIGS. 8A-8B illustrate example messages for indicating the beam spatial-Info parameters of RS resource indexes that the Rx node is configured to measure, according to certain embodiments;

FIG. 9 illustrates an example beam configuration for indicating the beam spatial-Info parameters of RS resource indicators, according to certain embodiments

FIG. 10 illustrates an example beam configuration for indicating the RSRQ values of all beam pairs between the reported SSB resource indexes and all the Rx beam, according to certain embodiments;

FIG. 11 illustrates an example beam configuration for indicating the RSRQ values associated with the reported/RS resource indicators, according to certain embodiments

FIG. 12 illustrates an example scenario including multiple sets of beam spatial-Info parameters for the case of multiple TRPs at the network side, according to certain embodiments;

FIG. 13 illustrates an example scenario including multiple sets of beam spatial-Info parameters for the case of multiple receive antenna panels at the UE side, according to certain embodiments;

FIG. 14 illustrates an example communication system, according to certain embodiments;

FIG. 15 illustrates an example UE, according to certain embodiments;

FIG. 16 illustrates an example network node, according to certain embodiments;

FIG. 17 illustrates a block diagram of a host, according to certain embodiments;

FIG. 18 illustrates a virtualization environment in which functions implemented by some embodiments may be virtualized, according to certain embodiments;

FIG. 19 illustrates a host communicating via a network node with a UE over a partially wireless connection, according to certain embodiments;

FIG. 20 illustrates an example method by a first radio node, according to certain embodiments; and

FIG. 21 illustrates an example method by a second radio node, according to certain embodiments.

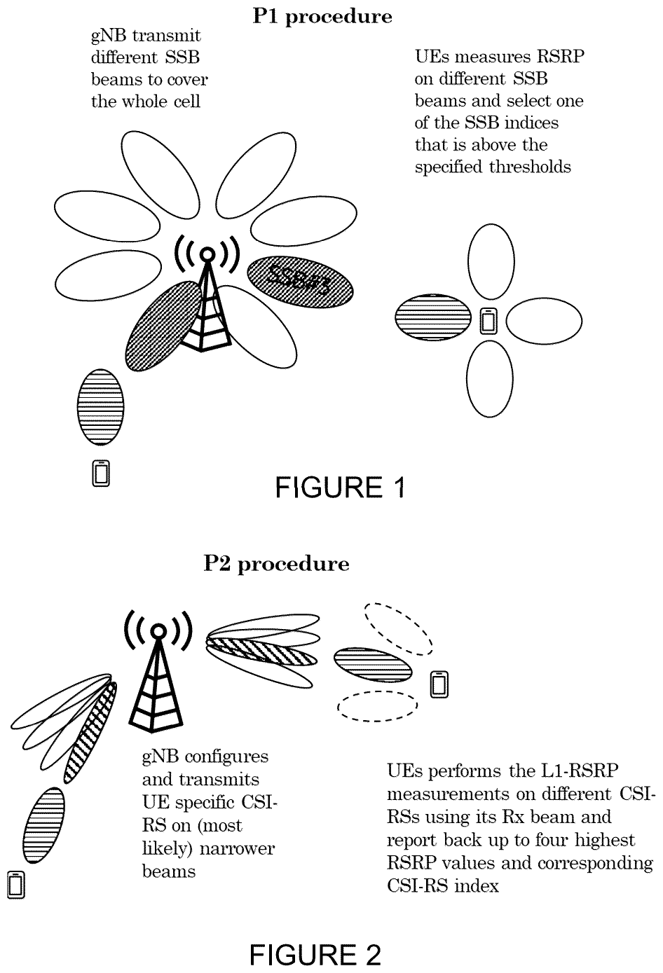

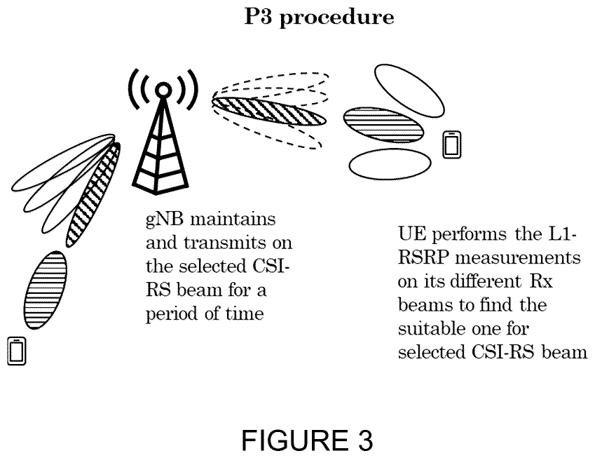

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ or ‘radio node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

According to certain embodiments, methods and systems disclosed herein include a first node providing beam-related information to a second node. The beamforming-related information indicates at least the spatial information of one or more reference signaling beam(s) transmitted from the first node, and this information is used by the second node to perform prediction of the quality of beam pairs between itself and the first node.

According to certain embodiments, the beamforming-related information indicates at least the spatial information of one or more reference signaling beam(s) transmitted from the first node, and this information is used by the second node to perform prediction of the quality of beam pairs between itself and the first node.

In various particular embodiments, the beamforming can be:
Horizontal beamforming only. In this case, the angle and related info (e.g., main lobe, beam width) in the spatial information only refers to azimuth angle.
Vertical beamforming only. In this case, the angle and related info (e.g., antenna mechanical or/and electrical down tilt) in the spatial information only refers to elevation angle.

Both horizontal and vertical beamforming (i.e., full-dimensional MIMO). In this case, the angle and related info (e.g., main lobe, beam width) in the spatial information refers to the angle pair: (azimuth angle and elevation angle), where azimuth angle indicates the horizontal beam direction, and elevation angle indicates the vertical beam direction.

### Case 1: The First Node is a Tx Node (e.g., gNB in DL) and the Second Node is a Rx Node (e.g., UE in DL)

As an example, prediction is done at the UE, UE has good knowledge about Rx beams and beam angles, but it does not have the info about Tx beam configurations, and beam angles of a RS beam transmitted from the gNB.

In this case, a new signaling from a Tx node to a Rx node is proposed to provide beam-related information of the Tx beams for the Rx node to perform beam pair prediction. For example, according to certain embodiments, the first node is a Tx node (e.g. radio access network (RAN) node, gNodeB, IAB node) and the second node is a Rx node such as User Equipment (UE). In this case, the Rx node (e.g., UE) receives beamforming related information from the Tx node (e.g., RAN node).

For example, according to certain embodiments, a method at or by a UE comprises any one or more of the following steps:
receiving one or more Tx beamforming information from the RAN node, wherein the Tx beamforming information comprises one or more parameters related to the spatial properties of the Tx beams at the RAN node;
performing one or more predictions of measurements of one or more Tx beams (or one or more Tx and Rx beam pairs) based on the one or more Tx beamforming information from the RAN node;
performing one or more actions using the one or more predictions of measurements of one or more Tx beams (or one or more Tx and Rx beam pairs), such as including in a report, triggering a procedure, etc.

As another example, according to certain embodiments, a method at and/or by a network node (such as, for example, a RAN node) includes:
transmitting one or more Tx beamforming information from the RAN node, wherein the Tx beamforming information comprises one or more parameters related to the spatial properties of the Tx beams at the RAN node.

It may be noted that this differs from the previous methods and techniques such as those in the existing version of the standard wherein only information about the reference signals are provided to the UE such as information about the SSBs resource index being transmitted, the periodicity, CSI-RS resources (in time and frequency domain). By contrast, the beam related information is related to a beam configuration (e.g. physical properties of the spatial domain transmission/spatial filter), and/or spatial correlation between different Tx beams, and/or at least one capability related to beamforming at the RAN node.

In a particular embodiment, the beam-related information indicates at least the spatial information of the RS beams transmitted from the Tx node. As examples, the RS(s) can be SSB(s), DMRS(s), CSI-RS(s), Tracking reference Signal(s) (TRSs) (NZP-CSI-RS with higher layer parameter trs-Info) or/and Sounding Reference Signals (SRSs).

### Defining the Beam Spatial-Info of a RS Beam

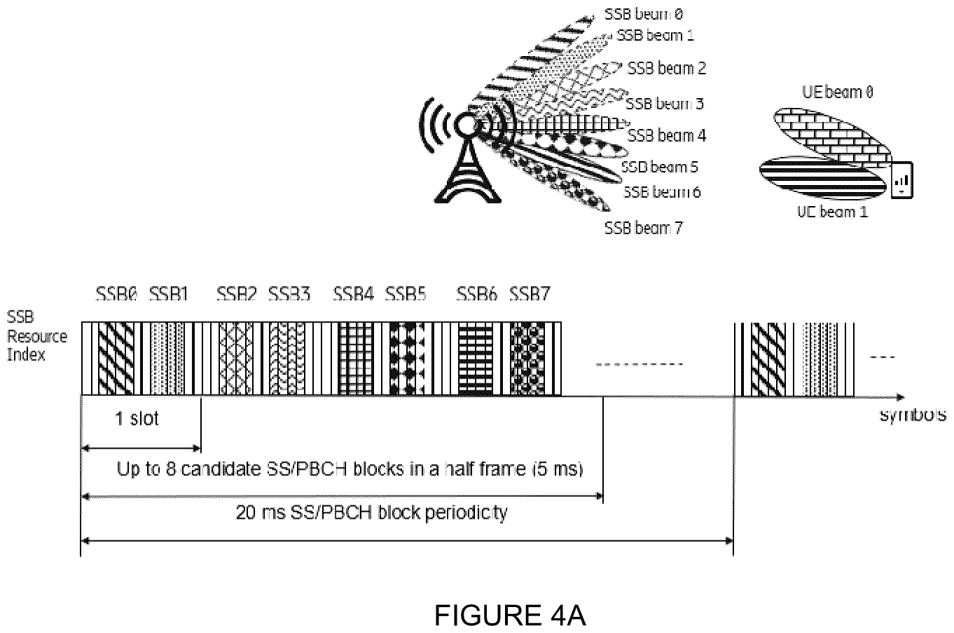

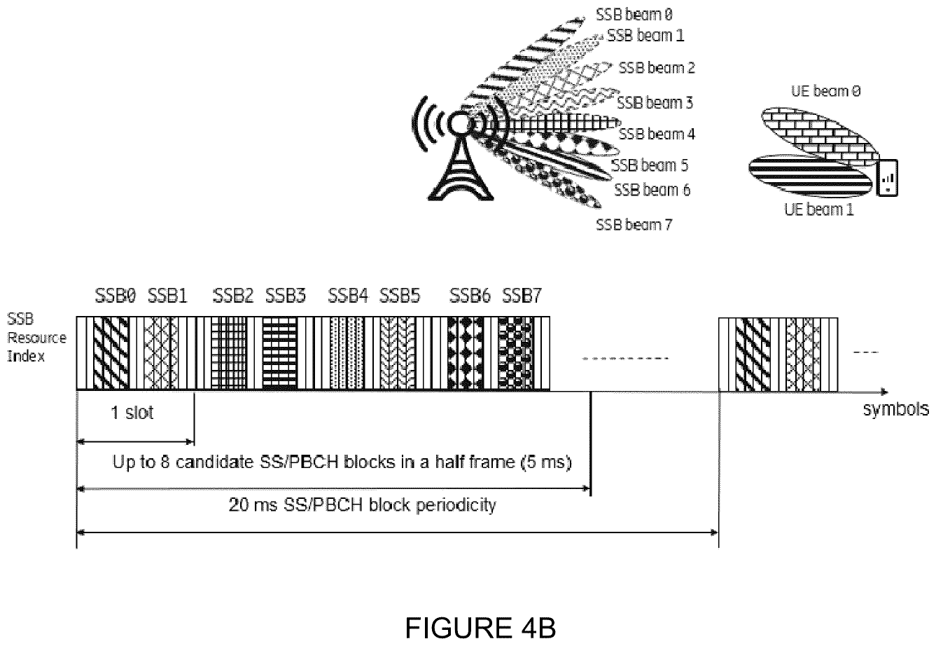

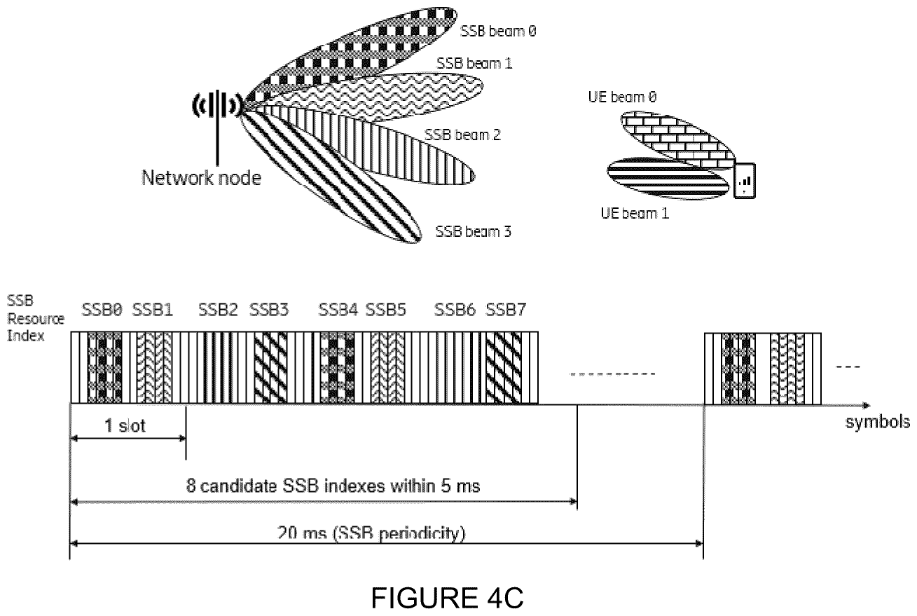

According to certain embodiments, the spatial information of the beam used for transmitting a RS from the Tx node can be indicated by a beam spatial-Info parameter/element, where the beam spatial-Info parameter/element can be defined by at least one of the following representations:
1. An index-based representation (i.e., a beam spatial-Info parameter/element consists of a single or multiple indexes) may include one or more of:
   An index of a beamforming weight-vector codebook, if Discrete Fourier Transform (DFT)-based beamforming is used for generating beams for the RS transmissions at the Tx node.
   An index that is defined by a spatial correlation between the beam used for the RS transmission and a specific RS beam. The specific RS beam is used as a reference beam for calculation of the spatial correlation. The index can be designed such that the beams with close index values have stronger spatial correlation. The beam related info of the specific RS beam may or may not be known at the Rx node.
   Multiple indices comprising a weighted combination of a predefined weight-vector codebook, including how much of each component one should add. The weight-vector codebook could in one embodiment be indicated to the Rx node.
   An index pointing to a range of the beam angle value indicates that the RS beam angle from the Tx node falls into this range. The index may include both the zenith (i.e., elevation) and azimuth angle of the main lobe of the beam.
   An index pointing to a range of the beam angle value difference compared to a reference angle value.
      This reference angle value can be either pre-defined or corresponds to the angle value of a specific RS.
      The index can be in respect to a peak of a sidelobe angle.
   An index pointing to a beam angle, where the gain is a certain predefined dB lower than the main-lobe angle. The index may include or represent both horizontal and azimuth direction.
2. A value-based representation (i.e., a beam spatial-Info parameter/element consists of a single or multiple values):
   The value of an RS beam can be used to reflect the spatial correlation between this RS beam and a specific RS beam. The specific RS beam is used as a reference beam for calculation of this value. The value can be designed such that the beams with close values have stronger spatial correlation.
      Returning to FIG. 4B as an example, assume that the SSB beam transmitted on the SSB resource index 0 is considered as a reference RS beam, and the value is set to 1 for this reference RS beam. Then, the values for other SSB beams can be obtained by using a formula, for example:

the value of a SSB beam=the value of the reference SSB beam+(step size*(the beam number of this SSB beam−the beam number of the reference SSB beam)
where step size can be configured or pre-defined. If setting the value of the step size to 0.1, then for SSB beam 1 that is transmitted on SSB resource index 4 as shown in FIG. 4B, its associated beam spatial-Info value can be calculated by 1+(0.1*(1−0))=1.1.
3. Antenna-pattern-based representation (i.e., a beam spatial-Info parameter/element consists of a pseudo-random function or/and a set of parameters that describing the antenna patten(s) includes at least one of:
   Indicating the N strongest beam(s) in a certain region with N>=1, and optionally the (beamformed) antenna gain for the N strongest beams (where the subsequent weaker beams could use relative coding of their gain) in said region, where the region is defined by the azimuth and zenith angle.
   Describing the antenna pattern and/or N strongest beams in a certain region via a pseudo-random function, where the network can indicate a set of parameters related to a certain antenna and/or beam setup, and the UE can use the pseudo-random function to generate the antenna gain and/or N strongest beams' information over the region or a limited subset of the region.

### Signalling the Beam Spatial-Info of All RS Beams to the UE

The Rx node (e.g. the UE) needs to understand the mapping between the beam spatial-Info and the transmitted RS by the Tx-node. For example, the relation between a specific SSB index and the beam spatial-Info, characterizing how the SSB is being transmitted by the Tx node (e.g. the RAN node). The Tx node signals the beam spatial-Info of the RS(s) to the Rx node using at least one of the following methods:

### Signaling the Spatial-Info of One of the (or All) the RS Beams

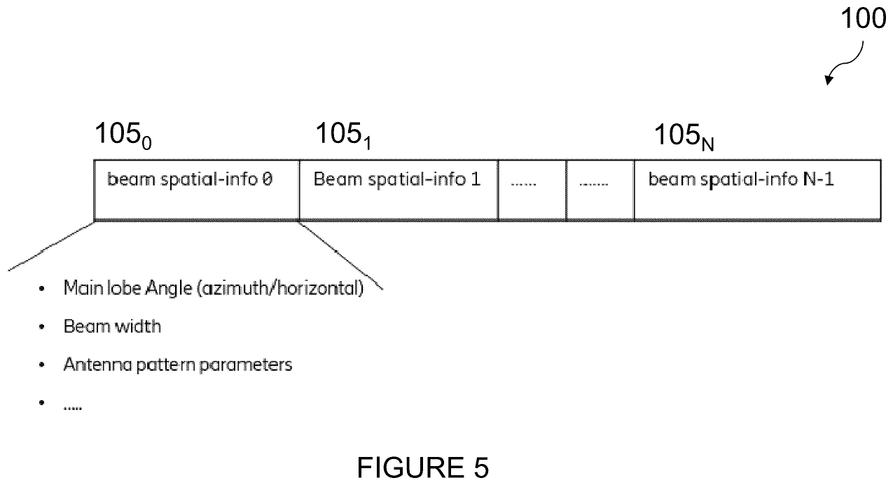

According to certain embodiments, the Tx node sends a message that consists of the beam spatial-Info parameter(s)/element(s) of at least one of the (or all) the RS beams being transmitted to the Rx node. The Rx-node receives a vector that consists of multiple beam spatial-Info parameters/elements, with each beam spatial-Info parameter/element indicating a spatial information of a single beam from the Tx node. This beam spatial-Info parameter/element can be constructed by using, e.g., the index-based representation, value-based representation, or/and antenna-pattern-based representation methods described before. FIG. 5 illustrates an example message 100 that consists of multiple beam spatial-Info parameters 105_{0, 1, . . . N} for multiple RS beams, according to certain embodiments.

In a particular embodiment, the message, for example, provides information for the UE to understand what beam, in the antenna pattern method, is transmitted on a certain RS. The UE can for example calculate in what angle region the beam is supposed to be strongest. In particular, the message may provide, for example, what parameters in the antenna pattern that can be used to map the SSB resource indexes.

In a particular embodiment, this message can be a different message as compared to the one used for configuring the Rx node to measure a subset of RS beams. In further particular embodiment, the different messages may be of the same message type such as, for example, two RRCReconfiguration messages. In yet another particular embodiment, the different messages may be of two different messages types. For example, the UE may receive the beam spatial-Info parameter(s)/element(s) in a System Information (SI) message (like a System Information Block (SIB) message) and the configuration of the Rx node to measure a subset of RS beams in an RRCReconfiguration message, in a particular embodiment.

According to certain particular embodiments, the RSs are SSB(s) having beam properties that do not change very often/very dynamically. Thus, the messages can be sent using an SIB message possibly acquired while the UE is in IDLE or INACTIVE state, or an RRC message while the UE is CONNECTED state before the Tx node configures a UE to perform P2/P3 based beam measurements. For example, the message may include an RRCReconfiguration message or an RRCResume message. The UE can also subscribe to updates regarding updates to the beams at the Tx-side.

One benefit in transmitting the information in dedicated signaling is that it may be transmitted only to UE's that are capable of using the information. On the other hand, one benefit in transmitting in system information is that the information may be useful for procedures before the UE enters RRC_CONNECTED e.g. random access.

In still other particular embodiments, the message is received by the UE in a same message (e.g. first RRCReconfiguration after transition from IDLE to CONNECTED) as the beam spatial-Info parameter(s)/element(s). In a particular embodiment, for example, this message is received by the UE after security has been established, as the content may reveal sensitive network information. For example, the message may be received after the Security Mode Command message, to establish initial Access Stratum security.

In a particular embodiment, the signaling included in the message, which may include one or more parameters for beam-related information, may include and/or be subject to delta signaling. For example, if one or more beam-related information is not included in the message, the UE assumes previously stored values for the same parameters to be valid and used.

The one or more parameters for beam-related information may be encoded as a payload in the Master Information Block (MIB), or encoded (at least partially encoded) in a sequence within a reference signal transmitted in a Tx beam associated to the one or more parameter. For example, if the property is about an SSB (which comprises DRMS, MIB payload, Primary Synchronization Signal (PSS), Secondary Synchronization Signal, etc.).

This signaling may be included in a handover command such as, for example, a RRCReconfiguration message including a reconfiguration with sync. In this case, the target network node includes its beam-related information in the handover command to the UE, so that when the UE accesses the target cell it knows the beam-related information and may use the information as input to predict beam pair information associated between the UE and the target cell after the handover.

Moreover, the Tx node also indicates a mapping between a list of RS resources indexes and a list of beam spatial-Info parameters contained in this message

In a particular embodiment, the mapping between the beam spatial-Info parameters and the transmitted RS(s) by the Tx-node can be defined as the information contained in the k-th beam spatial-Info parameter of the message corresponds to the k-th RS resource.

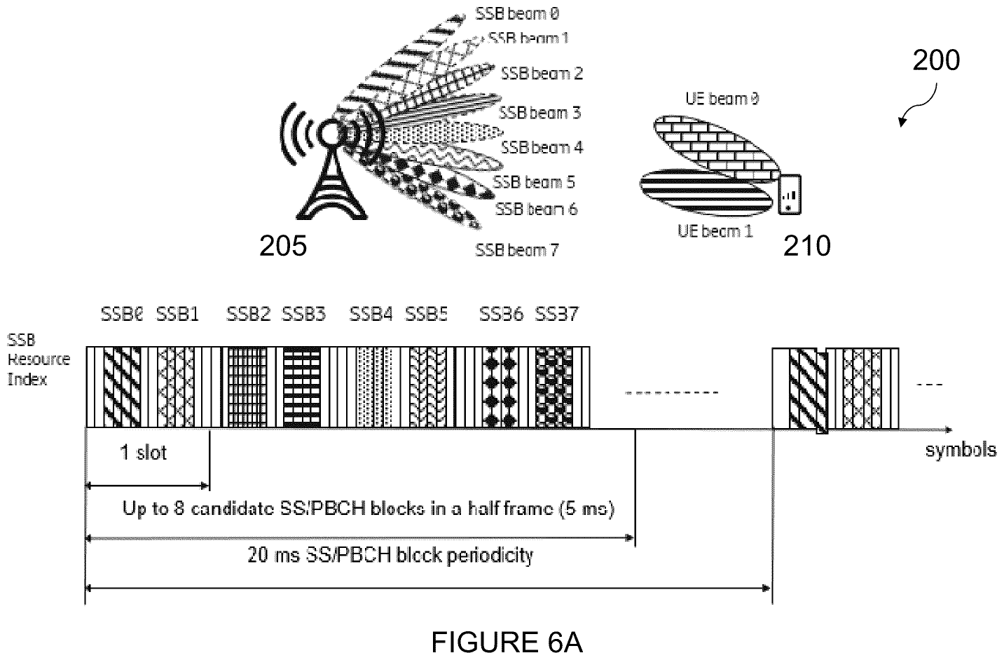

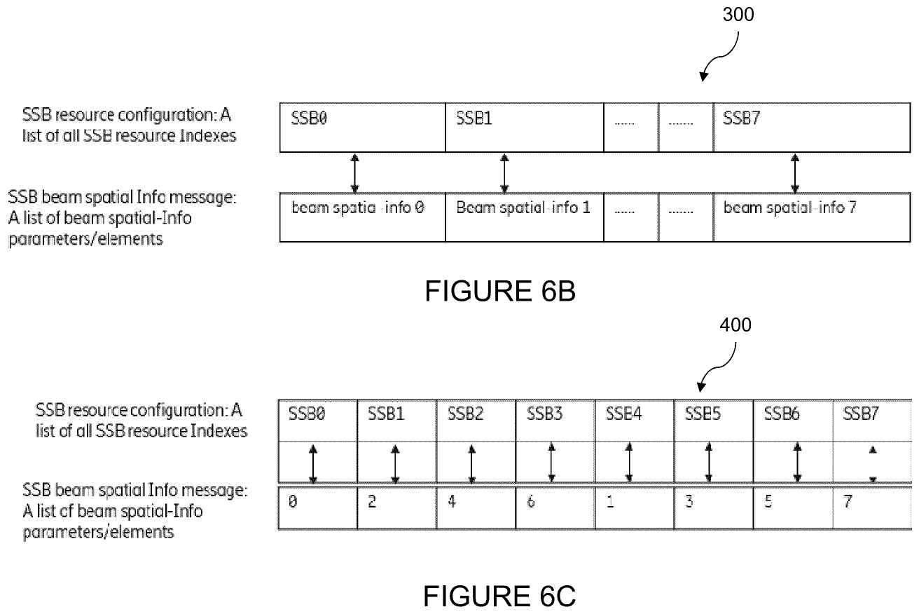

FIGS. 6A-6C illustrate example beam configurations for indicating the beam spatial-Info parameters of all RS resource indexes to the Rx node, according to certain embodiments. As depicted, RSs are SSBs.

In particular, in the example 200 shown in FIG. 6A, a network node 205 transmits 8 SSBs per SSB periodicity. These 8 SSBs are transmitted on different time occasions per SSB periodicity, and they are labeled as SSB resource Indexes 0 to 7. The network 205 configures a UE 210 to measure all or a subset of these SSBs for beam management, by indicating the corresponding SSB resource index(es) to the UE 210. In addition, the network node 205 sends a SSB beam spatial-Info message 300 to the UE 210, as shown in FIG. 6B, to indicate the mapping between these 8 SSB resource indexes and a list of 8 beam spatial-Info parameters/elements. In a particular embodiment, the k-th beam spatial-Info parameter/element contained in this message corresponds to the k-th SSB resource index.

Consider a special case, where the beam spatial-Info parameter/element is defined by using the index-based representation approach described above and each beam spatial-Info parameter/element consists of a single index for indicating the spatial information of the beam (e.g., the SSB beam index shown in [symbol] FIG. 6A), then, the message will be a list of indexes that represent the beam spatial-Info of all the RS beams. For the example shown in FIG. 6A, the 1st beam-spatial-Info parameter/element is defined by an index of value 0 (SSB beam 0), and it is associated to the 1^{st} SSB resource (SSB resource index 0); the 2^{nd} beam-spatial-Info parameter/element is defined by an index of value 2 (SSB beam 2), and it is associated to the 2^{nd} SSB resource (SSB resource index 1); the 3^{rd} beam-spatial-Info parameter/element is defined by an index of value 4 (SSB beam 4), and it is associated to the 3^{rd} SSB resource (SSB resource index 2); and so on. Hence, as shown in FIG. 6C, a message 400, which consists of the beam spatial-Info parameters/elements of all the 8 SSB beams, can be constructed by a list of indexes of values {0, 2, 4, 6, 1, 3, 5, 7}, that are mapped to the SSB resource indexes {0, 1, 2, 3, 4, 5, 6, 7}, respectively. Using this mapping knowledge, the Rx node can in future perform predictions of all beam pairs using the measurements based on only a subset of RS beams.

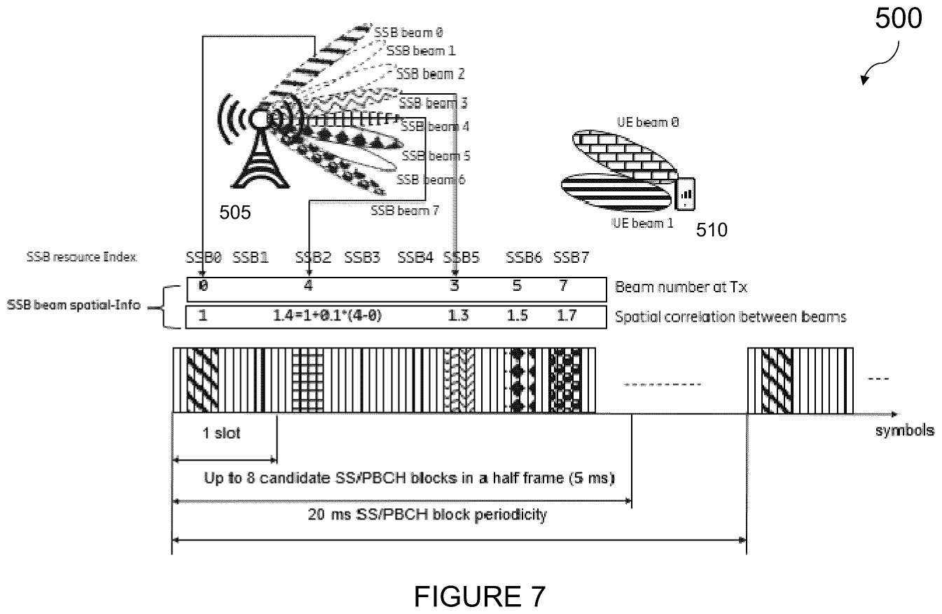

FIG. 7 illustrates an example beam configuration 500 for indicating the beam spatial-Info parameters of configured RS resource indexes to the Rx node, according to certain embodiments. Again, in the depicted example, RSs are SSBs

As shown in FIG. 7, even though there are 8 candidate SSB resources for transmitting SSBs per SSB periodicity, the network node 505 (i.e., gNB) only transmits SSB on five SSB resources (i.e., SSB0, SSB2, SSB5, SSB6 and SSB7) for a certain time duration. In this duration, the network configures a UE 510 to measure all or a subset of these five transmitted SSBs for beam management, by indicating the corresponding SSB resource index(es) to the UE 710. In addition, the network node 505 sends a SSB beam spatial-Info message (as shown in FIG. 7) to the UE 510 to indicate the mapping between these five SSB resource indexes and a list of five beam spatial-Info parameters/elements.

As shown in FIG. 7, if the spatial-Info parameter/element is defined by using the SSB beam index, a message, which consists of the beam spatial-Info parameters/elements of all the five SSB beams, can be constructed by a list of indexes of values {0, 4, 3, 5, 7}, which are mapped to the SSB resource indexes {0, 2, 5, 6, 7}, respectively.

If the spatial-Info parameter/element is defined by using a value that is defined by a spatial correlation between the SSB beam and a reference SSB beam (e.g., the first transmitted SSB within a SSB periodicity, that is, SSB beam 0 in FIG. 7), then, a message, which consists of the beam spatial-Info parameters/elements of all the five SSB beams, can be constructed by a list of spatial correlation values (e.g., {1, 1.4, 1.3, 1.5, 1.7} shown in FIG. 7), which are mapped to the SSB resource indexes {0, 2, 5, 6, 7}, respectively. Here, the correlation value is calculated by setting the value to 1 for the reference SSB beam, i.e., SSB beam 0, and setting the values for other transmitted SSB beams according to a formular, the value of a SSB beam=the value of the reference SSB beam+(step size*(the beam number of this SSB beam-the beam number of the reference SSB beam), where step size is set to 0.1. For instance, the value for SSB beam 4 transmitted on SSB resource index 2 is obtained as 1+(0.1*(4−0))=1.4.

In particular embodiments, the message, which consists of the beam spatial-Info parameter(s)/element(s) of all the RS beams, is part of an SIB message, RRC message, or DCI.

As described above, in particular embodiments, the message can be a different message as compared to the one used for configuring the Rx node to measure a subset of RS beams.

For some cases, for example, RSs are SSB(s), and the beam(s) doesn't change very often. In this scenario, the message can be sent using an SIB message or a RRC message before the Tx node configures a UE to perform P2/P3 based beam measurements.

In a particular embodiment, the Rx node may subscribe to updates regarding updates to the beams at the Tx-side.

As an example, assume that the Tx node is a gNB, and the Rx node is a UE. The message, which consists of the beam spatial-Info parameter(s)/element(s) of all the RS beams, is contained in the RRC IE ServingCellConfigCommon or/and ServingCellConfigCommonSIB. For instance, assume that N is the number of actual transmitted SSBs determined according to the parameter ssb-PositionsInBurst in SIB1, then, for each actual transmitted SSB, a beam spatial-Info parameter/element is provided in this message. Therefore, the total number of beam spatial-Info parameter(s)/element(s) contained in this message is N.

In an embodiment, in addition to the beam spatial-Info parameter(s)/element(s), the message may also include a reference value of beam measurements (e.g., a RSRP, RSRQ or SINR value) for the reference RS, if configured/indicated. The reference value of beam measurements can be used for the UE to check the difference between the measured RSRP and the configured RSRP. For instance, in a particular embodiment, if the measured RSRP is higher than the threshold, the UE could do (1) or (2)+(3):
(1) Skip the measurements of the remaining configured RSs (for P2)
(2) Measure only some RSs with high correlations to see whether better beam can be found or not (for P2)
(3) Measure the RSs with low correlation using other Rx beams (for P3)
   One advantage is that joint P2 and P3 can be performed. Another advantage is that the UE could predict the RSRP of configured RSs or even the RSs which are not configured with the beam-spatial-Info.

### Signaling Only the Spatial-Info of the RSs That the UE is Configured to Measure

According to certain other embodiments, the Tx node sends a message consisting of the beam spatial-Info parameters/elements of only the RS resource indexes that the Rx node is configured to measure. For example, in addition to indicating the RS resource indexes that the Rx node shall measure, the measurement resource configuration message may include the corresponding beam spatial-Info parameters/elements of these RS resource indexes.

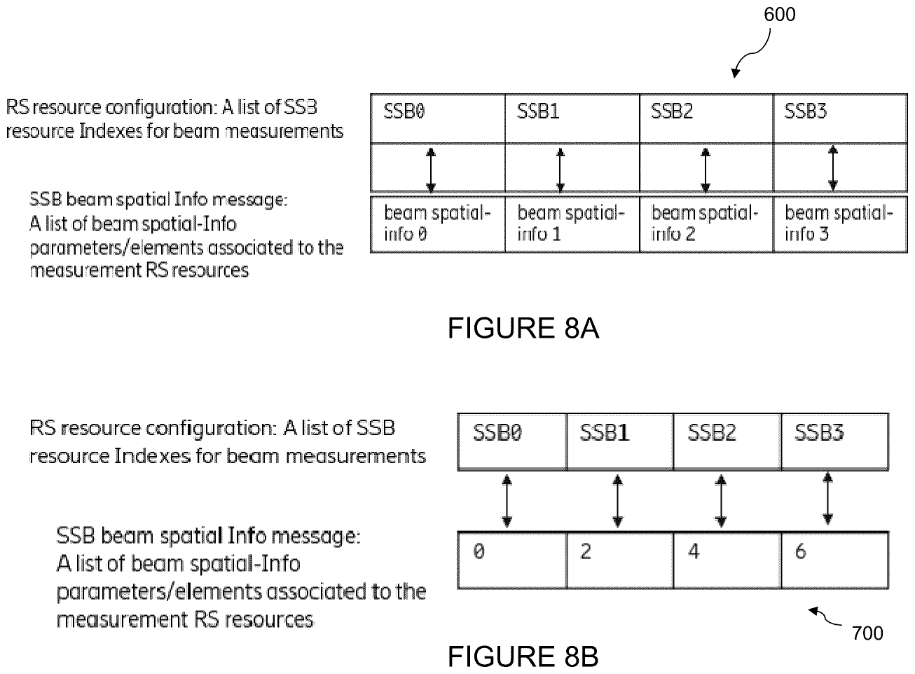

FIGS. 8A and 8B illustrate example messages indicating the beam spatial-Info parameters of RS resource indexes that the Rx node is configured to measure, according to certain embodiments. As depicted, RSs are SSBs.

As depicted, even though the Tx node transmits SSB beams in 8 different SSB resource indexes, it only configures the Rx node to perform measurements on SSB resource indexes 0, 1, 2, and 3. In addition, the Tx node provides the associated beam spatial-Info parameters of the beams transmitted on these four SSB resource indexes to the Rx node, i.e., the SSB spatial information message 600 shown in FIG. 8A. For a special case, where the beam spatial-Info parameter/element is defined by using the index-based representation approach, and each beam spatial-Info parameter/element consists of a single index for indicating the spatial information of the beam (e.g., the SSB beam index shown in FIG. 8B), SSB beam spatial information message 700 is {0,2,4,6}, which represents the beam spatial-Info of the SSB resource indexes {0,1,2,3}.

In a particular embodiment, the message provides, for example, information for the UE to understand what beam, in the antenna pattern method, that is transmitted on a certain RS.

In a particular embodiment, this message is part of an SIB message, RRC message, or DCI.

In a particular embodiment, the message is the one used for configuring the RX node to measure a subset of RS beams. For instance, the message may be contained in the associated CSI-ResourceConfig IE, where the candidate RS resources for beam measurement is configured.

From reducing signaling overhead perspective, this method fits better for the cases where the beams for RS(s) transmission change dynamically, e.g., CSI-RS based beam measurements. In one example embodiment, this can be configured as part of the Quasi Co-Located (QCL) source configuration, wherein for a given RS it is provided an indication of the Tx beam configuration for that RS.

Rx Node (e.g., UE) Requesting the Beam Spatial-Info From the Tx Node (e.g., gNB)

In a particular embodiment, the UE transmits a request to the RAN node, requesting the RAN node to provide the UE with its Tx beam related information. In response to the request, the UE may receive the Tx beam related information of the RAN node.

In a further particular embodiment, the request corresponds to a Physical Random Access Chanell (PRACH) resource, such as preamble and/or a time/frequency domain PRACH resource. In response, the UE receives a Random Access Response (RAR) including one or more indications of the Tx beam related information of the RAN node.

In a further particular embodiment, the request is included in an RRCReconfigurationComplete message. This could be the response to a transition to RRC_CONNECTED from RRC_IDLE, wherein the UE equipped with an ML-model for predicting beam pair(s) needs and/or benefits from the beam-related information from the RAN node. In response, the UE receives another RRC message (e.g., another RRCReconfiguration) including one or more indications of the Tx beam related information of the RAN node.

In a particular embodiment, the request is included in an RRC Resume Request message (e.g. RRCResumeRequest or RRCResumeRequest1). This could be the response to a transition to RRC_CONNECTED from RRC_INACTIVE, wherein the UE equipped with an ML-model for predicting beam pair(s) needs and/or benefits from the beam-related information from the RAN node. In response the UE receives the RRCResume message including one or more indications of the Tx beam related information of the RAN node.

In another particular embodiment, the request is included in an RRCSetupRequest. This could be the response to a transition to RRC_CONNECTED from RRC_IDLE, wherein the UE equipped with an ML-model for predicting beam pair(s) needs and/or benefits from the beam-related information from the RAN node. In response the UE receives an RRCSetup message including one or more indications of the Tx beam related information of the RAN node.

In another particular embodiment, the request may be included in an RRCResumeComplete message. In one example, this is in response to a transition to RRC_CONNECTED from RRC INACTIVE, when the UE has an ML-model for predicting beam pair(s) which needs and/or benefits from the beam-related information from the RAN node, and when the RAN node configured the UE to perform a beam related procedure requiring the UE to perform beam pair measurements and/or beam pair prediction(s). In response the UE may receive a UE Information Request message including one or more indications of the Tx beam related information of the RAN node (and possibly including a request for further information from the UE, related to the UE's beamforming properties, to be transmitted by the UE in a UE Information Response message).

In another particular embodiment, the request may be included in an RRCSetupComplete message. In one example, this is in response to a transition to RRC_CONNECTED from RRC_IDLE, when the UE has an ML-model for predicting beam pair(s) which needs and/or benefits from the beam-related information from the RAN node, and when the RAN node configured the UE to perform a beam related procedure requiring the UE to perform beam pair measurements and/or beam pair prediction(s). In response, the UE may receive a UE Information Request message including one or more indications of the Tx beam related information of the RAN node (and possibly including a request for further information from the UE, related to the UE's beamforming properties, to be transmitted by the UE in a UE Information Response message).

In another particular embodiment, the request may be included in an RRCReconfigurationComplete message. In one example, this is in response to a transition to RRC_CONNECTED from RRC_IDLE, or after a handover. In response, the UE may receive a UE Information Request message including one or more indications of the Tx beam related information of the RAN node (and possibly including a request for further information from the UE, related to the UE's beamforming properties, to be transmitted by the UE in a UE Information Response message).

### Rx Node Receiving the Beam Spatial-Info From the Tx Node

According to certain embodiments, the Rx node (e.g., UE) receives the Tx beam related information from the Tx node (e.g., RAN node such as a gNB) per serving cell. For example, the Rx node may receive one or more configurations for each serving cell (e.g., Special Cell (SpCell) and/or one or more Secondary Cells (Scells)) of a cell group (e.g., Master Cell Group (MCG) and/or Secondary Cell Group (SCG)). In one example embodiment, the Tx beam related information of the RAN node per cell is included within the IE ServingCellConfig (per SpCell and Scell) within a cell group configuration.

According to certain embodiments, the UE receives the Tx beam related information of the RAN node per cell group (e.g., MCG) and/or SCG). In one example, the Tx beam related information of the RAN node per cell group is included within the IE CellGroupConfig (for SpCell and configured Scells) for MCG or SCG.

In a particular example embodiment, one or more SCell(s) or cells configured for carrier aggregation may have similar beam properties and/or beam-related configuration as the SpCell. Thus, in a particular embodiment, the UE receives Tx beam related information associated to a referred by a configuration ID, index or identifier, and the ID refers to one or more beam(s) and/or reference signals of multiple serving cells. For example, the UE may receive a configuration ID related to one SSB of the PCell and another SSB of an SCell. This may be useful to further reduce signaling.

According to certain embodiments, the UE receives the Tx beam related information of the RAN node per neighbor cell or frequency such as, for example, in a measurement object.

### Sharing Beam Spatial-Info Between Tx Nodes

According to certain embodiments, network nodes may share this information with each other. For example, in a deployment with a Central Unit (CU) and Distributed Unit (DU), the DU may indicate to the CU its Tx beam related information, so that the UE generates an RRC message including the information to the UE.

### Case 2: The First Node is a Rx Node and the Second Node is a Tx Node

According to certain embodiments, prediction is done at the gNB. The gNB has good knowledge about Tx beams but has no info about Rx beams at the UE. In this case, a new reporting from a Rx node to a Tx node is proposed to provide beam-related information of the Rx beams for the Tx node to perform beam pair prediction. Thus, according to certain embodiments, the first node is a Rx node (e.g., UE in DL) and the second node is a Tx node (e.g., RAN node, gNB, IAB node, etc.), and the Tx node receives beamforming related information from the Rx node. More specifically, according to certain embodiments, a method at and/or by a UE includes reporting (i.e., transmitting) one or more Rx beamforming information to the RAN node. The Rx beamforming information comprises one or more parameters related to the spatial properties of Rx beams at the UE.

As another example, according to certain embodiments, a method at and/or by a network node comprises includes receiving one or more Rx beamforming information from the UE, and the Rx beamforming information comprises one or more parameters related to the spatial properties of the Rx beams at the UE. In a particular embodiment, the network node performs one or more predictions of measurements of one or more Rx beams (or one or more Tx and Rx beam pairs) based on the one or more Rx beamforming information from the UE. Additionally or alternatively, the network node may perform or more actions using the one or more predictions of measurements of one or more Rx beams (or one or more Tx and Rx beam pairs).

The beam-related information indicates at least the spatial information of the Rx beams used at the Tx node for measuring the RS beams transmitted from the Tx node. As examples, the RS(s) transmitted from the Tx node can be SSB(s), DMRS(s), CSI-RS(s), or/and SRS(s). s Defining the Beam Spatial-Info of a Rx Beam at UE

Similar to as described above, the spatial information of a Rx beam of the Rx node used for receiving a RS transmitted from the Tx node can be indicated by a beam spatial-Info parameter/element, where the beam spatial-Info parameter/element can be defined by at least one of the following representations:
1. An index-based representation (i.e., a beam spatial-Info parameter/element consists of a single or multiple indexes):
   For example, the beam spatial-Info may include or be represented as an index of a beamforming weight-vector codebook if DFT-based beamforming is used for generating the Rx beams.
   As another example, the beam spatial-Info may include or be represented as an index that is defined by a spatial correlation between the Rx beam and a specific Rx beam. The specific Rx beam is used as a reference beam for calculating the spatial correlation. The index can be designed such that the beams with close index values have stronger spatial correlation. The beam related info of the specific RX beam may or may not be known at the Tx node.
   As still another example, the beam spatial-Info may include or be represented as multiple indices that include a weighted combination of a predefined weight-vector codebook, including how much of each component one should add. The weight-vector codebook could in one particular embodiment be indicated to the Tx node.
   As still another example, the beam spatial-Info may include or be represented as an index pointing to a range of the beam angle value indicates that the Rx beam angle falls into this range. The beam spatial-Info may include both the zenith and azimuth angle of the main lobe of the beam.
   As still another example, the beam spatial-Info may include or be represented as an index pointing to a range of the beam angle value difference compared to a reference angle value.
      In a particular embodiment, this reference angle value can be either pre-defined or correspond to the angle value of a specific Rx beam.
      In a particular embodiment, the index can be in respect to a peak of a sidelobe angle.
   As still another example, the beam spatial-Info may include or be represented as an index pointing to a beam angle, where the gain is a certain predefined dB lower than the main-lobe angle. In both horizontal and azimuth direction.
2. A value-based representation (i.e., a beam spatial-Info parameter/element consists of a single or multiple values). The value of an Rx beam can be used to reflect the spatial correlation between this Rx beam and a specific Rx beam. The specific Rx beam is used as a reference beam for calculation of this value. The value can be designed such that the beams with close values have stronger spatial correlation. Similar methods as described for Case 1.
3. Antenna-pattern-based representation (i.e., a beam spatial-Info parameter/element consists of a pseudo-random function or/and a set of parameters that describing the antenna patten(s). Similar methods as described for Case 1 above.

### Reporting the Rx Beam Including its Beam Spatial-Info From a UE to the gNB

According to certain particular embodiments, the Rx node reports the beam spatial-Info parameter(s) of the RS(s) to the Tx node using one or more methods described below.

For example, in a particular embodiment, the Rx node reports to the Tx node a message consisting of a list of beam spatial-Info parameter(s)/element(s) of all Rx beams that can be used for beam measurement. That is, the Rx-node reports a vector that consists of multiple beam spatial-Info parameters/elements, with each beam spatial-Info parameter/element indicating spatial information of a single beam used by the Rx node, as an example shown in FIG. 5. This beam spatial-Info parameter/element can be constructed by using, e.g., the index-based representation, value-based representation, and/or antenna-pattern-based representation methods described above.

In a particular embodiment, this message can be a different message than the one used for reporting beam measurements.

In a particular example embodiment, the information is transmitted as part of the UE capability reporting such as, for example, as part of the capabilities related to beamforming. That may differ for different frequency carriers and/or frequency bands, and/or frequency ranges (e.g., FRI may have one configuration, while FR2 may have another configuration).

In a particular embodiment, this message may be transmitted to the Tx node as part of the Rx node capability information associated with beam management.

In a particular embodiment, the Rx node sends a message indicating a list of the beam spatial-Info parameter(s)/element(s) of the Rx beam(s) associated with the reported RSRP value(s) and RS index(es). This message may be the one used for the Rx node to report its beam measurements. For example, it may be transmitted as part of the CSI report. However, other different options may also be considered for forming such a message:

In a particular embodiment, in addition to reporting the selected RS resource Indicator(s) (e.g., CRIs or/and SSBRIs) and the associated RSRP value(s), the measurement report message also contains information that indicates the corresponding beam spatial-Info parameter of the Rx beam used for measuring each of the reported RS resource indicator.

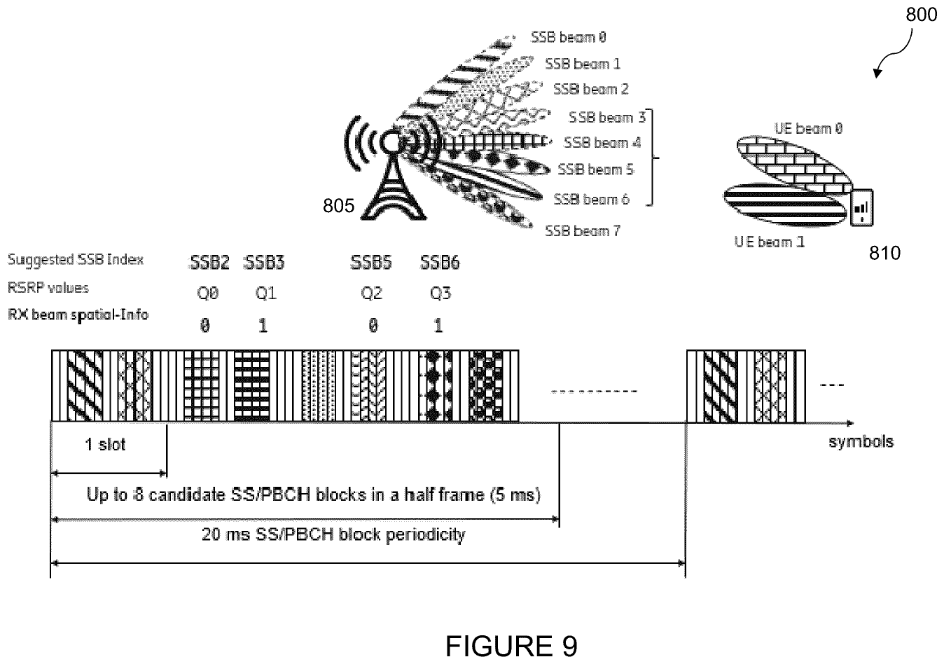

FIG. 9 illustrates an example beam configuration 800 for indicating the beam spatial-Info parameters of the reported RS resource indicators, according to certain embodiments. In the depicted example, a Rx node (i.e., UE) 810 uses 2 RX beams for beam measurement and is configured to measure 8 different SSB beams (SSBs transmitted on SSB resource indexes 0-7) and report 4 best SSB resource indicators including one RSRP value per reported SSB resource indicator. In addition, the UE 810 reports the beam spatial-Info of the Rx beam used for measuring each of the 4 reported SSBs. Here, the beam spatial-Info is defined by the SSB beam index shown in FIG. 9. Here, Q0>Q1>Q2>Q3, where Q0, Q1, Q2, and Q3 are RSRP values for the beam pairs {Tx beam transmitted on SSB index 2, Rx beam 0}, {Tx beam transmitted on SSB index 3, Rx beam 1}, {Tx beam transmitted on SSB index 5, Rx beam 0} and {Tx beam transmitted on SSB index 6, Rx beam 1}, respectively. The reported 4 beam spatial-Info parameters are {0, 1, 0, 1}, and they are the RX beam indexes used for measuring SSB resource indexes {2, 3, 5, 6}, respectively.

In another particular embodiment, in addition to the reported RS resource indicators, the measurement report message also contains information that indicates RSRP values of all pairs between the reported RS resource indicators and all the Rx beams. In a particular embodiment, if the Rx node 810 has already reported a list of beam spatial-Info parameters of all its Rx beams to the Tx node 805, the RSRP values can be reported in a defined order associated with the order of the beam spatial-Info parameters. Thus, there is no need to report the beam spatial-Info parameters of RX beams again to the Tx node 805. Otherwise, the beam spatial-Info parameters may also be included in the measurement report message.

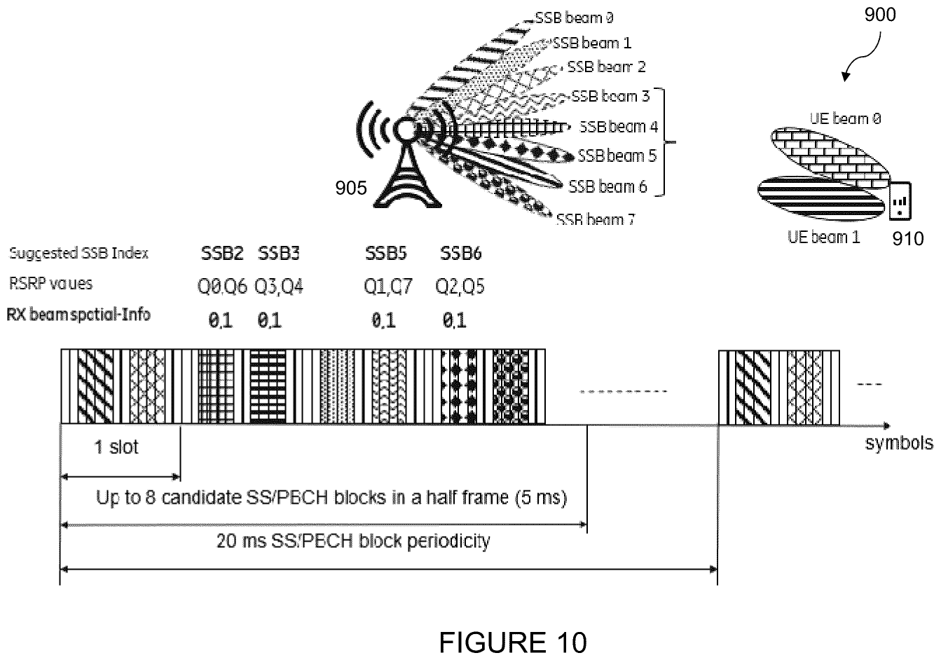

FIG. 10 illustrates an example beam configuration 900 for indicating the RSRQ values of all beam pairs between the reported SSB resource indexes and all the Rx beams, according to certain embodiments. Specifically, as shown in FIG. 10, the Rx node 910 (i.e., UE) uses 2 Rx beams for beam measurement. It measures 8 different RS beams and reports 4 suggested RS beams to the Tx node. In addition, it reports 4*2=8 RSRP values, with each RSRP value associated with a beam pair between a reported RS resource indicator and a Rx beam. Specifically, Q0>Q1>Q2>Q3, where Q0-Q3 are the RSRP values for the beam pairs between the four reported SSB resource indexes and the Rx beam 0; and Q4>Q5>Q6>Q7, where Q4-Q7 are the RSRP values for the beam pairs between the four reported SSB indexes and the Rx beam 1.

In another particular embodiment, the Rx beam(s) to use for the Rx node 910 to perform beam measurements on the configured RS resource index(es) is/are configured by the Tx node 905. The Tx node 905 may consider the Rx node 910 to use the same Rx beam for measuring all configured RS resource indexes or use different Rx beams for measuring different RS resource indexes. The beam measurement report consists of information that indicates the suggested RS resource indicator(s) and the associated RSRP values. As these RSRP values are measured using the RX beam(s) instructed by the Tx node 905, there is no need to report the Rx beam spatial-info parameters to the Tx node 905. In a particular embodiment, this assumes that the Tx node 905 already received from the Rx node 910 list of beam spatial-Info parameters of all its Rx beams for beam measurements.

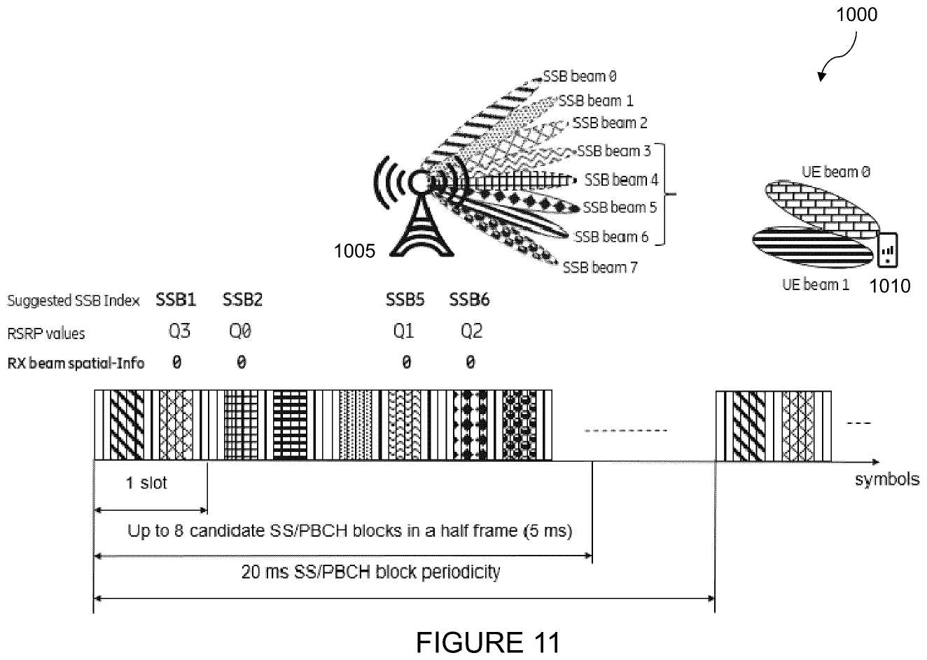

FIG. 11 illustrates an example beam configuration 1000 for indicating the RSRQ values associated with the reported/RS resource indicators where the Rx beam 0 is used when performing the beam measurements, according to certain embodiments. As shown, a Rx node 1010 (i.e., UE) uses 2 Rx beams for beam measurement. It measures 8 different RS resource indexes and reports 4 best RS beams to the Tx node 1005. In addition, the Rx node 1010 is asked to perform the beam quality measurements using the Rx beam 0. Thus, each reported RSRP value is associated with a beam pair between a reported RS resource index and the configured Rx beam to measure (i.e., Rx beam 0 in this example). In the depicted example, Q0>Q1>Q2>Q3, where Q0-Q3 are the RSRP values for the beam pairs between the four reported SSB resource indexes and the Rx beam 0.

It is noted that, although the examples are given using SSB as RS for DL beam measurements, the same methodology can be applied for the cases where CSI-RS is used as the RS. In addition, although the examples are given using RSRP reports, the same methodology can be applied for other types of report like RSRQ or/and SINR values.

### Multi-TRP at Tx Node

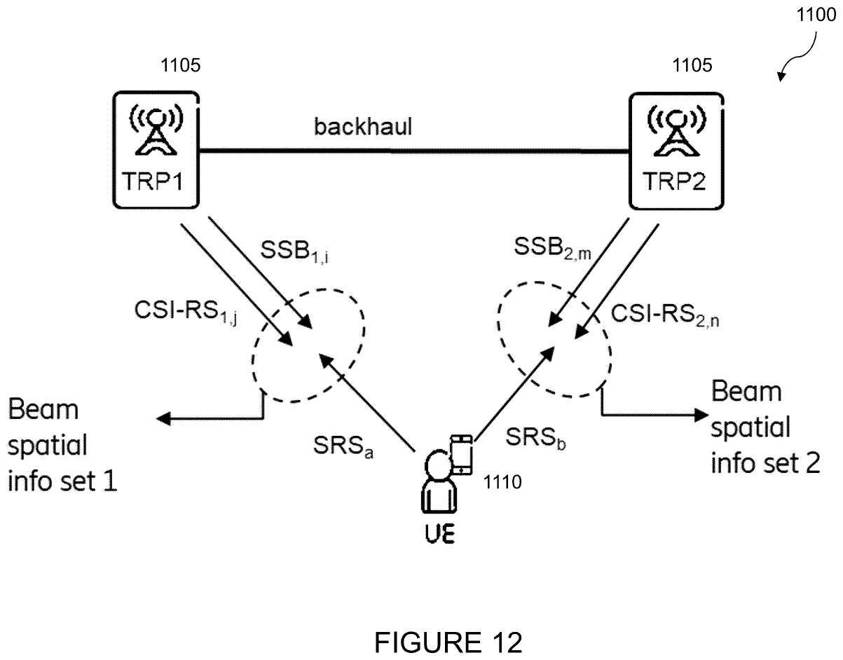

In the example embodiments described above, unless explicitly stated, single TRP is assumed for the Tx node (e.g., gNB). When there are multiple-TRP at the Tx side, then M sets of the spatial information for the beams are to be defined and signaled, one set per TRP, where M is the number of TRPs. This then allows the beam management procedure to be performed separately for each TRP. FIG. 12 illustrates an example scenario 1100 that includes multiple sets of beam spatial-Info parameters for the case of multiple TRPs 1105 assuming that the Tx node is a gNB and the Rx node is a UE 1110. For a given TRP 1105, the beam spatial information can be constructed as if the Tx node is a single-TRP. However, the discussion below assumes M=2 (i.e., 2 TRPs at the Tx node), with the understanding that the same methodology can be simply extended to M>2 cases.

Utilizing the beam spatial information for the M TRPs, the beam management algorithm can separately identify the best beam pair (best_beam_pair #1) associated with TRP1, and the best beam pair (best_beam_pair #2) associated with TRP2. This simplifies the search space for the algorithm to find the best beam pair. This is reasonable since the beams associated with the two TRPs are not tightly correlated (ideally, they are independent and uncorrelated), and methods like interpolation/extrapolation cannot be used across beams of two different TRPs.

Then the two beam pairs (best_beam_pair #1, best_beam_pair #2) can be used simultaneously (e.g., TRP1 and TRP2 simultaneously transmit DL signal/channel to the UE 1110). Alternatively, the better beam pair among the two, (best_beam_pair #1, best_beam_pair #2), can be selected and used to leverage the diversity and robustness afforded by the presence of two TRPs 1105, when the UE 1110 communicates with a single TRP 1105 at a time.

In a particular embodiment, the beam spatial information for the M TRPs can be implicitly or explicitly grouped.

In a particular example embodiment, since TRP is not explicitly indexed in NR, the beam spatial information for the M TRPs can be implicitly grouped and associated with each TRP, similar to those of TCI state, CORSET pool (for PDCCH monitoring) and DMRS (for PDSCH reception). For example, if two CORESET pools are configured, one for each TRP, then the beam spatial information can be grouped into two sets, one associated with each of the CORESET pool. In another example, if DMRS of PDSCH of TRP1 belongs to a first CDM group, and DMRS of PDSCH of TRP2 belongs to a second CDM group that is orthogonal to those of first CDM group, then the beam spatial information can be grouped into two sets, one associated the first DMRS CDM group, the other associated with the second DMRS CDM group.

In another example, two sets of beam spatial information are built, where a first subset of SSBs belong to the first beam spatial information set, and a second subset of SSBs belong to the second beam spatial information set. This implies that the first subset of SSBs are transmitted from TRP1, and the second subset of SSBs are transmitted from TRP2. Then other DL RS (e.g., CSI-RS, TRS (a special type of CSI-RS)) that are quasi-co-located (QCL-ed) with any of the SSB in the first subset are understood to be associated with TRP1, while those DL RS that are QCL-ed with any of the SSB in the second subset are understood to be associated with TRP2. Similarly, for UL reference signals, if an UL SRS is configured to have a spatial relation with a DL RS (e.g., SSB or CSI-RS) of TRP1 (or TRP2), then this UL SRS is understood to be associated with TRP1 (or TRP2). This allows two sets of beam spatial information to be constructed, one for the DL and/or UL RS of TRP1, the other for the DL and/or UL RS of TRP2.

### Multi-Panel at Rx Node

When there are multi-panel at the Rx node, then N sets of the spatial information for the Rx beams are to be defined and reported, one set per panel, where N is the number of receive antenna panels at the Rx node. This then allows the beam management procedure to be performed separately for each panel.

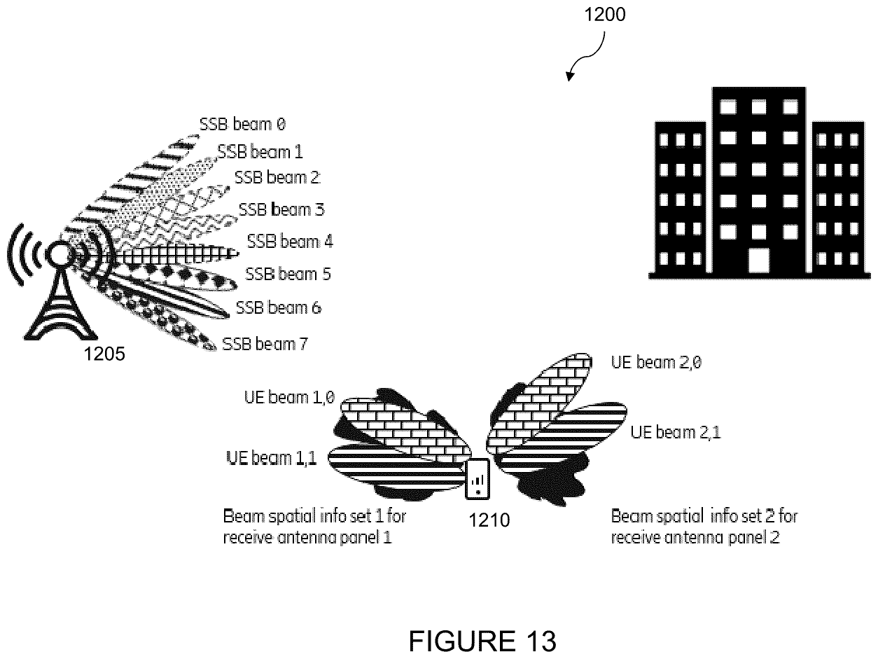

FIG. 13 illustrates an example beam configuration 1200 that includes multiple sets of beam spatial-Info parameters for the case of multiple receive antenna panels at UE side, according to certain embodiments The illustrated example assumes that the Tx node 1205 is a gNB and the Rx node 1210 is a UE. For a given receive antenna panel at the Rx node 1210, the beam spatial information can be constructed as if the Rx node 1210 has a single receive antenna panel.

The discussion below assumes N=2 (i.e., 2 panels at the Rx node 1210), with the understanding that the same methodology can be simply extended to N>2 cases.

Similar to the multi-TRP case, utilizing the spatial information of the multiple receive antenna panels, the beam management algorithm can separately identify the best beam pair (best_beam_pair #1) associated with panel 1 and the best beam pair (best_beam_pair #2) associated with panel 2. This simplifies the search space for the algorithm to find the best beam pair. Then the two beam pairs (best_beam_pair #1, best_beam_pair #2) can be used simultaneously (e.g., panel 1 and panel 2 simultaneously receive DL signal/channel from the gNB). Alternatively, the better beam pair among the two (best_beam_pair #1, best_beam_pair #2) can be selected and used to leverage the diversity and robustness afforded by the presence of two antenna panels when the gNB communicates with a single receive antenna panel at the UE at a time.

The beam spatial information for the N receive antenna panels can be implicitly or explicitly grouped and reported to the Tx node 1205.

In one example, the panel is explicitly indexed and reported to the Tx node 1205. For each panel ID, the UE reports a set of beam spatial-Info parameter(s)/element(s) for all or a subset of Rx beams associated to this panel. As the example shown in FIG. 13, the Rx node 1210 reports beam spatial information set 1 for panel 1 and beam spatial information set 2 for panel 2. The reporting methods described for case 2 can be reused.

In a particular embodiment, the panel is implicitly indexed, and the UE reports a combined set of beam spatial-Info parameter(s)/element(s) for all or a subset of Rx beams for all panels. The combined set of beam spatial information for all panels can be constructed by conducting the beam spatial information set for each panel, which may include, for example, {beam spatial information set 1, beam spatial information set 2} for the example of two-panel Rx node shown in FIG. 13. The reporting methods described for case 2 can also be reused for this case.

It is noted that even though the above examples are given assuming the communication between the first node and the second node are over the Uu interface (e.g., the first node is a gNB/IAB/relay-node and the second node is a UE, or the first node is a UE, and the second node is a gNB/IAB/relay-node), the same methodology can be applied for the device-to-device communications over the PC5 interference such as, for example, when the first node is a UE and the second node is another UE.

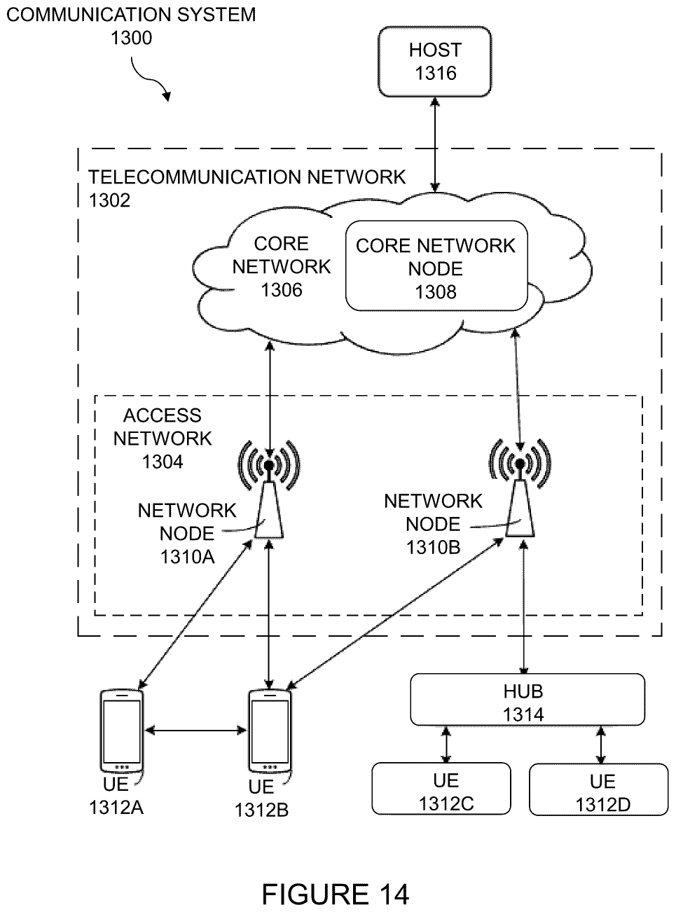

FIG. 14 shows an example of a communication system 1300 in accordance with some embodiments. In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3rd Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub-that is, a hub whose primary function is to route communications to/from the UEs from/to the network node 1310b. In other embodiments, the hub 1314 may be a non-dedicated hub-that is, a device which is capable of operating to route communications between the UEs and network node 1310b, but which is additionally capable of operating as a communication start and/or end point for certain data channels.

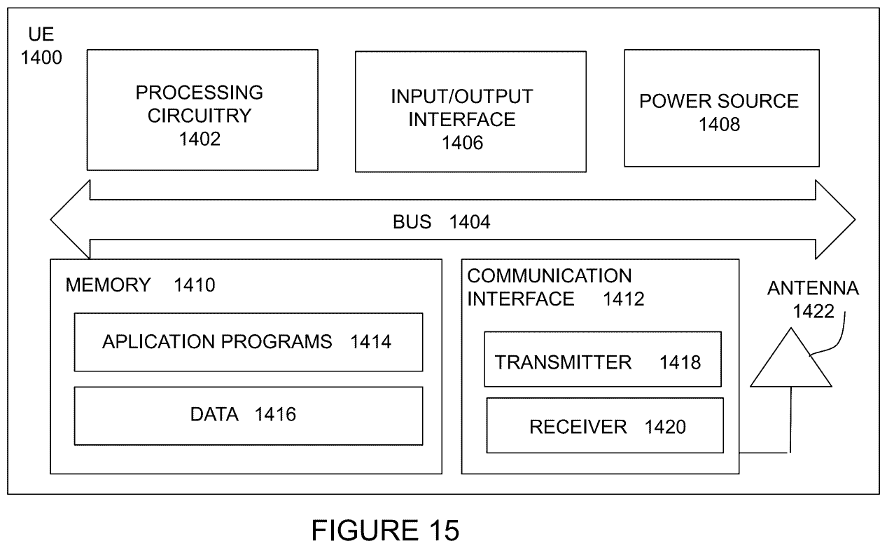

FIG. 15 shows a UE 1400 in accordance with some embodiments.

As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment

(LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

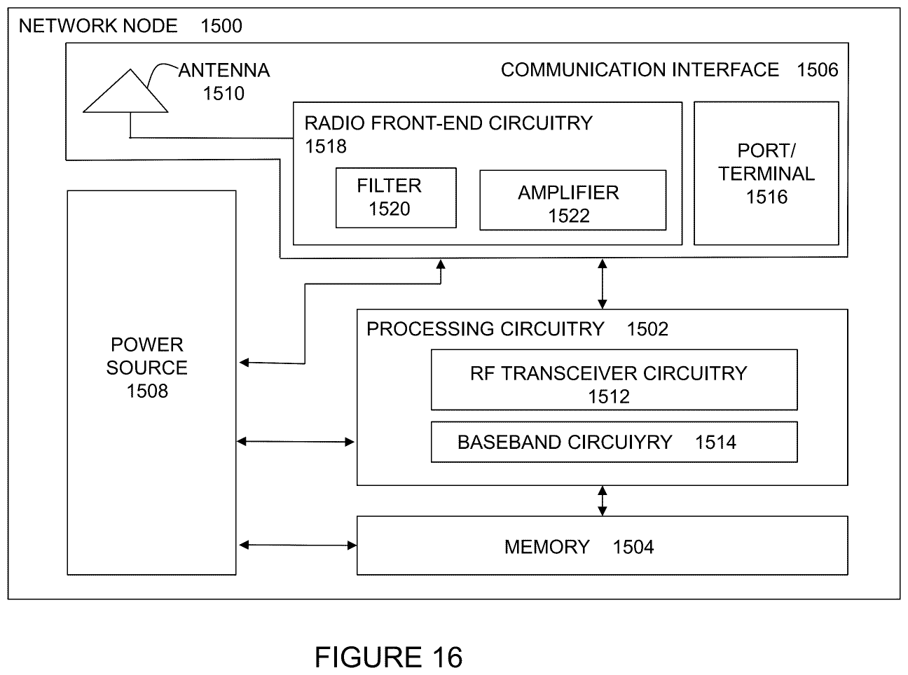

FIG. 16 shows a network node 1500 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 16 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

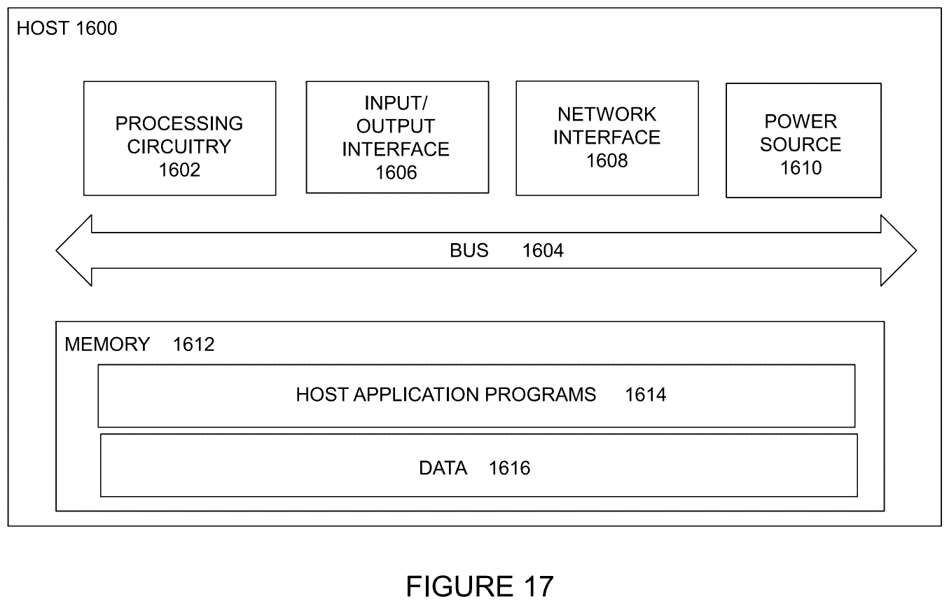

FIG. 17 is a block diagram of a host 1600, which may be an embodiment of the host 1316 of FIG. 14, in accordance with various aspects described herein.

As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

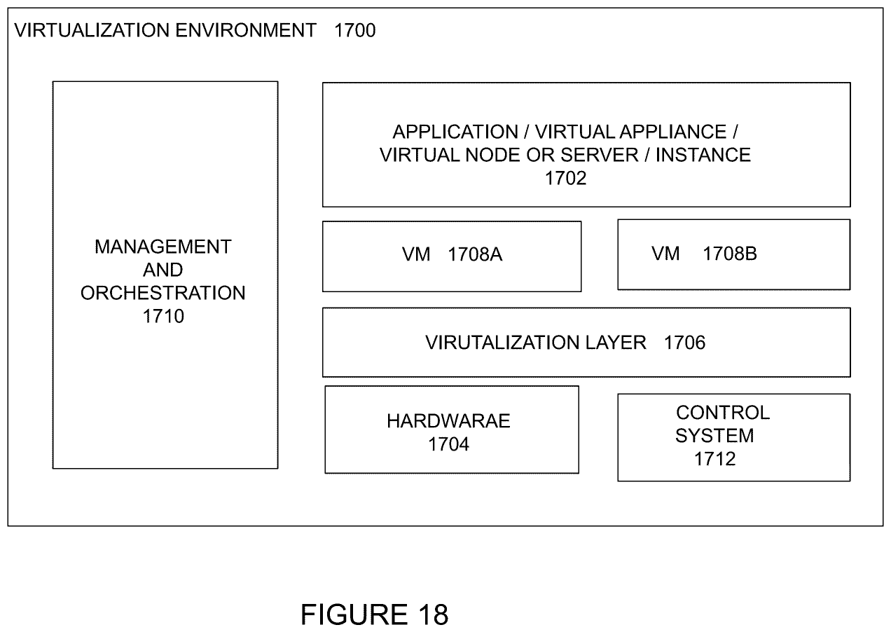

FIG. 18 is a block diagram illustrating a virtualization environment 1700 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

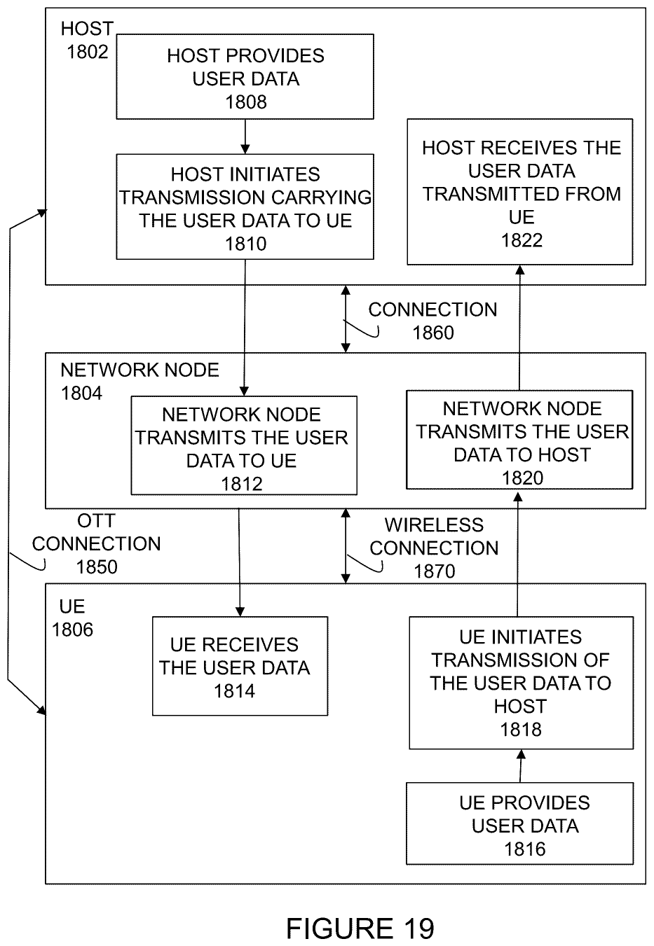

FIG. 19 shows a communication diagram of a host 1802 communicating via a network node 1804 with a UE 1806 over a partially wireless connection in accordance with some embodiments.

Example implementations, in accordance with various embodiments, of the UE (such as a UE 1312a of FIG. 14 and/or UE 1400 of FIG. 15), network node (such as network node 1310a of FIG. 14 and/or network node 1500 of FIG. 16), and host (such as host 1316 of FIG. 14 and/or host 1600 of FIG. 17) discussed in the preceding paragraphs will now be described with reference to FIG. 19.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 14) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

FIG. 19 illustrates an example method 1900 by a first radio node, according to certain embodiments. The method includes receiving beamforming information from a second radio node, at step 1902. The beamforming information includes at least one parameter related to at least one spatial property of at least one reference signal beam. As just one example, first and second radio nodes described with respect to FIG. 19 may include radio nodes 205, 210 described above with respect to FIG. 6A or any other radio nodes described above with respect to FIGS. 7, 9, 10, 11, 12, 13. Additionally, first and second radio nodes may include any combination of network nodes and/or UEs such as, for example, network node 1310 and UE 1312 as depicted in FIG. 14.

In a particular embodiment, prior to receiving the beaming information, the first radio node transmits, to the second radio node, a request for the beamforming information.

In a particular embodiment, the request for the beam forming information is included in at least one of: a PRACH request corresponding to a PRACH resource, a RRC Reconfiguration Complete message, a RRC Resume Request message, a RRC Setup Request message, a RRC Resume Complete message, and a RRC Setup Complete message.

In a particular embodiment, the beamforming information related to the at least one spatial property comprises at least one of: a beam configuration, a spatial correlation between two or more reference signal beams, and a capability related to beamforming at the second radio node.

In a particular embodiment, based on the beamforming information, the first radio node predicts a quality of the at least one reference signal beam. Additionally or alternatively, based on the beamforming information and/or the predicted quality of the at least one reference signal beam, the first radio node performs at least one action.

In a particular embodiment, predicting the quality of the at least one reference signal beam includes predicting at least one measurement value for the at least one reference signal beam. The at least one reference signal beam includes at least one of: at least one transmit signal beam, at least one receive signal beam, and at least one transmit-receive signal beam pair.

In a particular embodiment, when performing the at least one action, the first radio node performs at least one of: including the quality and/or the at least one measurement value predicted for the at least one reference signal beam in a measurement report, and/or initiating a beam management procedure based on at least one of the beamforming information, the at least one predicted quality of the at least one reference signal beam, and the at least one predicted measurement value for the at least one reference signal beam.

In a particular embodiment, the beamforming information is associated with horizontal beamforming and the at least one spatial property comprises at least one azimuth angle of the at least one reference signal beam. Additionally or alternatively, the beamforming information is associated with vertical beamforming and the at least one spatial property comprises at least one elevation angle of the at least one reference signal beam.

In a particular embodiment, the beamforming information related to the at least one spatial property further includes at least one of: a main lobe direction, a main lobe beam width, a side lobe direction, a side lobe beam width, an antenna mechanical down tilt, and an electrical down tilt.

In a particular embodiment, the beamforming information related to the at least one spatial property is represented as at least one index, wherein the at least one index is associated with at least one of: a beamforming weight-vector codebook and/or a weighted combination of a predefined weight-vector codebook; a spatial correlation between the at least one reference signal beam and a specific reference beam; a range of beam zenith angle values and/or azimuth angle values; a horizontal beam angle and/or a azimuth direction beam angle; at least one value representing a spatial correlation between the at least one reference signal and a specific reference beam; and at least one antenna pattern indicating a number of strongest reference signal beams.

In a particular embodiment, the first radio node comprises a UE, the second radio node comprises another UE or a network node, the at least one reference signal beam comprises at least one transmit reference signal beam associated with the second radio node, and the beamforming information comprising the at least one parameter related to the at least one spatial property is associated with the at least one transmit reference signal beam.

In a particular embodiment, the first radio node transmits, to the second radio node, a first message that includes at least one parameter related at least one spatial property of at least one receive reference signal beam used by the first radio node to perform at least one measurement.

In a particular embodiment, the first radio node transmits, in a second message, a beam measurement reporting of at least one value associated with the reference signal beams. The first message includes the at least one parameter is different from the second message that includes the beam measurement reporting.

In a particular embodiment, the first radio node is a network node, and the second radio node is a UE. The at least one reference signal beam is at least one receive reference signal beam associated with the second radio node, and the beamforming information includes the at least one parameter related to the at least one spatial property of the at least one receive reference signal beam.

In a particular embodiment, the at least one reference signal beam includes at least one of: at least one SSB, at least one DMRS, at least one CSI-RS, at least one TRS, at least one PRS, and at least one SRS.

In a particular embodiment, when receiving the beamforming information, the first radio node receives the beamforming information in a first message that comprises beamforming information for a set of reference signal beams being transmitted from the second radio node. Alternatively, the first radio node receives the beamforming information in a first message that comprises beamforming information for a subset of a set of reference signal beams being transmitted from the second radio node.

In a further particular embodiment, the first radio node receives, in a second message, a configuration for measuring the set or the subset of reference signal beams.

In a particular embodiment, the first message is received in DCI, a SIB message while the first radio node is in an IDLE or INACTIVE state, or an RRC message while the first radio node is in a CONNECTED state.

In a particular embodiment, the first radio node receives a mapping between a list of reference signal resources indexes and a list of beam spatial-Info parameters, and the information contained in the k-th beam spatial-Info parameter of the list of beam spatial-Info parameters corresponds to the k-th reference signal resource index of the list of reference signal resource indexes.

In a particular embodiment, the beamforming information includes at least one of a minimum threshold and a maximum threshold for performing a comparison of at least one beam measurement value associated with the at least one reference signal beam.

In a particular embodiment, the second radio node comprises a multiple-TRP node having M number of TRPs, and the beamforming information comprises M sets of beamforming information. Each one of the M sets of beamforming information comprises at least one parameter related to the at least one spatial property of at least one reference signal beam associated with a particular TRP. Additionally or alternatively, the first radio node comprises a multiple-panel node having N number of receive antenna panels, and the beamforming information comprises N sets of beamforming information. Each one of the N sets of beamforming information comprises at least one parameter related to the at least one spatial property of at least one reference signal beam to be received by a particular antenna panel.

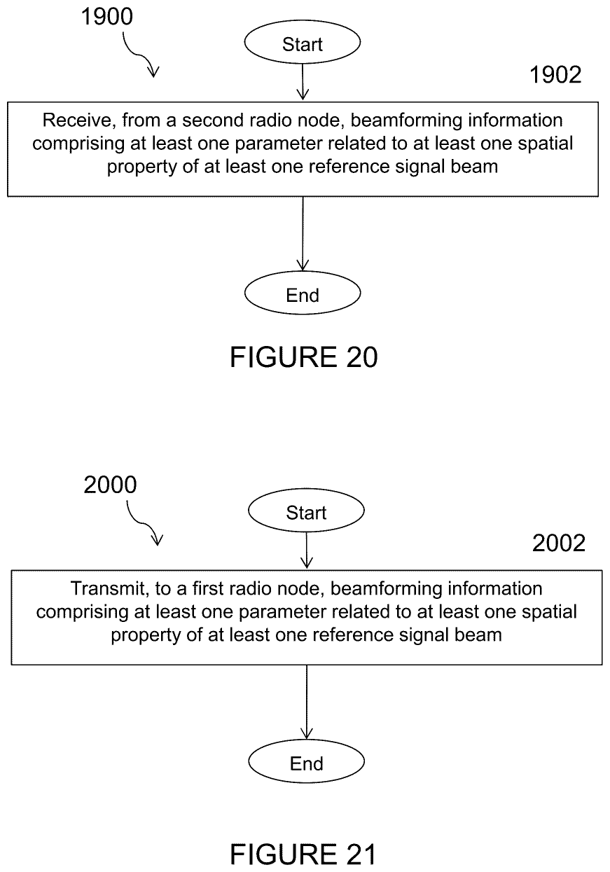

FIG. 20 illustrates an example method 2000 by a second radio node, according to certain embodiments. The method includes transmitting beamforming information to a first radio node, at step 2002. The beamforming information includes at least one parameter related to at least one spatial property of at least one reference signal beam. As just one example, first and second radio nodes described with respect to FIG. 19 may include radio nodes 205, 210 described above with respect to FIG. 6A or any other radio nodes described above with respect to FIGS. 7, 9, 10, 11, 12, 13. Additionally, first and second radio nodes may include any combination of network nodes and/or UEs such as, for example, network node 1310 and UE 1312 as depicted in FIG. 14.

In a particular embodiment, prior to transmitting the beamforming information, the second radio node receives, from the first radio node, a request for the beamforming information.

In a particular embodiment, the request for the beam forming information is included in at least one of: a PRACH request corresponding to a PRACH resource, a RRC Reconfiguration Complete message, a RRC Resume Request message, a RRC Setup Request message, a RRC Resume Complete message, and a RRC Setup Complete message.

In a particular embodiment, the beamforming information related to the at least one spatial property comprises at least one of: a beam configuration, a spatial correlation between two or more reference signal beams, and a capability related to beamforming at the first radio node.

In a particular embodiment, based on the beamforming information, the second radio node predicts a quality of the at least one reference signal beam and/or performs at least one action.

In a further particular embodiment, predicting the quality of the at least one reference signal beam includes predicting at least one measurement value for the at least one reference signal beam. The at least one reference signal beam includes at least one of: at least one transmit signal beam, at least one receive signal beam, and at least one transmit-receive signal beam pair.

In a particular embodiment, performing the at least one action includes at least one of: including the quality and/or the at least one measurement value predicted for the at least one reference signal beam in a measurement report; initiating a beam management procedure based on at least one of the beamforming information, the at least one predicted quality of the at least one reference signal beam, and/or the at least one predicted measurement value for the at least one reference signal beam; and/or adjusting at least one parameter of at least one reference signal beam to be transmitted by the second radio node to the first radio node.

In a particular embodiment, the beamforming information is associated with horizontal beamforming and the at least one spatial property comprises at least one azimuth angle of the at least one reference signal beam. Additionally or alternatively, the beamforming information is associated with vertical beamforming, and the at least one spatial property comprises at least one elevation angle of the at least one reference signal beam.

In a particular embodiment, the beamforming information related to the at least one spatial property comprises at least one of: a main lobe direction, a main lobe beam width, a side lobe direction, a side lobe beam width, an antenna mechanical down tilt, and an electrical down tilt.

In a particular embodiment, the beamforming information related to the at least one spatial property is represented as at least one index, and the at least one index is associated with at least one of: a beamforming weight-vector codebook and/or a weighted combination of a predefined weight-vector codebook; a spatial correlation between the at least one reference signal beam and a specific reference beam; a range of beam zenith angle values and/or azimuth angle values; a horizontal beam angle and/or a azimuth direction beam angle; at least one value representing a spatial correlation between the at least one reference signal and a specific reference beam; and at least one antenna pattern indicating a number of strongest reference signal beams.

In a particular embodiment, the second radio node comprises network node, and the first radio node comprises a UE. The at least one reference signal beam comprises at least one transmit reference signal beam associated with the second radio node, and the beamforming information comprising the at least one parameter related to the at least one spatial property is associated with the at least one transmit reference signal beam.

In a particular embodiment, the second radio node receives, from the first radio node, a first message comprising at least one parameter related at least one spatial property of at least one receive reference signal beam used by the second radio node to perform at least one measurement. In a further particular embodiment, the second radio node receives, in a second message, a beam measurement reporting of at least one value associated with the reference signal beams, and the first message comprising the at least one parameter is different from the second message that includes the beam measurement reporting.

In a particular embodiment, the second radio node is UE, and the first radio node is a network node or another UE. The at least one reference signal beam comprises at least one receive reference signal beam associated with the second radio node, and the beamforming information comprises the at least one parameter related to the at least one spatial property of the at least one receive reference signal beam.

In a particular embodiment, the at least one reference signal beam comprises: at least one SSB, DMRS, CSI-RS, and SRS.

In a particular embodiment, transmitting the beamforming information includes: transmitting the beam forming information in a first message that comprises beamforming information for a set of reference signal beams being transmitted from the second radio node, or transmitting the beam forming information in a first message that comprises beamforming information for a subset of a set of reference signal beams being transmitted by the second radio node.

In a particular embodiment, the second radio node transmits, to the first radio node, in a second message, a configuration for measuring the set or the subset of reference signal beams.

In a particular embodiment, the first message is transmitted in DCI, a SIB message while the first radio node is in an IDLE or INACTIVE state, or a RRC message while the first radio node is in a CONNECTED state.

In a particular embodiment, the second radio node transmits, to the first radio node, a mapping between a list of reference signal resources indexes and a list of beam spatial-Info parameters. The information contained in the k-th beam spatial-Info parameter of the list of beam spatial-Info parameters corresponds to the k-th reference signal resource index of the list of reference signal resource indexes.

In a particular embodiment, the beamforming information includes at least one of a minimum threshold and a maximum threshold for performing a comparison of at least one beam measurement value associated with the at least one reference signal beam.

In a particular embodiment, the second radio node is a multiple-TRP node having M number of TRPs, and the beamforming information comprises M sets of beamforming information. Each one of the M sets of beamforming information comprises at least one parameter related to at least one spatial property of at least one reference signal beam associated with a particular TRP. Additionally or alternatively, the first radio node is a multiple-panel node having N number of receive antenna panels, and the beamforming information comprises N sets of beamforming information. Each one of the N sets of beamforming information includes at least one parameter related to at least one spatial property of at least one reference signal beam to be received by a particular antenna panel.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for beam pairing prediction, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for beam pairing prediction, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a first radio node for beam pairing prediction, method comprising: receiving, from a second radio node, beamforming information comprising at least one parameter related to at least one spatial property of at least one reference signal beam.

Example Embodiment C2. The method of Example Embodiment C1, wherein the beamforming information comprises at least one of: a beam configuration, a spatial correlation between two or more reference signal beams, and/or a capability related to beamforming at the second radio node.

Example Embodiment C3. The method of any one of Example Embodiments C1 to C2, wherein the beamforming information is associated with horizontal beamforming, and wherein the spatial information comprises at least one azimuth angle of the at least one reference signal beam.

Example Embodiment C4. The method of any one of Example Embodiments C1 to C2, wherein the beamforming information is associated with vertical beamforming, and wherein the spatial information comprises at least one elevation angle of the at least one reference signal beam.

Example Embodiment C5. The method of any one of Example Embodiments C1 to C2, wherein the beamforming information is associated with horizontal and vertical beamforming, and wherein the spatial information comprises at least one azimuth angle and at least one elevation angle of the at least one reference signal beam.

Example Embodiment C6. The method of any one of Example Embodiments C1 to C5, wherein the beamforming information further comprises at least one of: a main lobe, a beam width, an antenna mechanical down tilt, and an electrical down tilt.

Example Embodiment C7. The method of any one of Example Embodiments Cl1 to C6, wherein the beamforming information is represented as at least one of: at least one index of a beamforming weight-vector codebook and/or a weighted combination of a predefined weight-vector codebook; at least one index defined by a spatial correlation between the at least one reference signal beam and a specific reference beam; at least one index pointing to a range of beam zenith angle values and/or azimuth angle values; at least one index pointing to a horizontal beam angle and/or a azimuth direction beam angle; at least one value representing a spatial correlation between the at least one reference signal and a specific reference beam; and at least one antenna pattern indicating a number of strongest reference signal beams.

Example Embodiment C8. The method of any one of Example Embodiments C1 to C7, further comprising at least one of: based on the beamforming information, predicting a quality of the at least one reference signal beam; and based on the beamforming information and/or the predicted quality of the at least one reference signal beam, performing at least one action.

Example Embodiment C9. The method of Example Embodiment C8, wherein predicting the quality of the at least one reference signal beam comprises predicting at least one measurement value for the at least one reference signal beam.

Example Embodiment C10. The method of Example Embodiment C9, wherein predicting the at least one measurement value for the at least one reference signal beam comprises at least one of: predicting the at least one measurement value for at least one transmit signal beam; predicting the at least one measurement value for at least one receive signal beam; and predicting the at least one measurement value for a transmit-receive signal beam pair.

Example Embodiment C11. The method of any one of Example Embodiments C8 to C10, wherein performing the at least one action comprises at least one of: including the quality and/or the at least one measurement value predicted for the at least one reference signal beam in a measurement report, and/or initiating a procedure based on at least one of: the beamforming information, the at least one predicted quality of the at least one reference signal beam, and/or the at least one predicted measurement value for the at least one reference signal beam.

Example Embodiment C12A. The method of any one of Example Embodiments C1 to C11, wherein: the first radio node comprises a user equipment (UE), the second radio node comprises another UE or a network node, and the at least one reference signal beam comprises at least one transmit reference signal beam associated with the second radio node; and the beamforming information comprises the at least one parameter related to the at least one spatial property of the at least one transmit reference signal beam.

Example Embodiment C12B. The method of Example Embodiment 12A, further comprising transmitting, to the second radio node, a message comprising at least one parameter related at least one spatial property of at least one receive reference signal beam used by the first radio node to perform at least one measurement.

Example Embodiment C12C. The method of Example Embodiment C12B, wherein the message comprises at least one capability of the first radio node to report beamforming measurement information.

Example Embodiment C12D. The method of Example Embodiment C12B to C12C, wherein the message is different from a message that includes a beam measurement reporting of at least one measurement value associated with the reference signal beams.

Example Embodiment C13. The method of any one of Example Embodiments C1 to C12D, wherein the at least one reference signal beam comprises: at least one SSB, at least one DMRS, at least one CSI-RS, at least one TRS, and/or at least one SRS.

Example Embodiment C14. The method of any one of Example Embodiments C1 to C13, wherein: the first radio node comprises a network node, the second radio node comprises a user equipment (UE), and the at least one reference signal beam comprises at least one receive reference signal beam associated with the second radio node, and the beamforming information comprises the at least one parameter related to the at least one spatial property of the at least one receive reference signal beam.

Example Embodiment C15A. The method of any one of Example Embodiments C1 to C14, wherein receiving the beamforming information comprises receiving the beam forming information in a first message that comprises beamforming information for a plurality of reference signal beams (i.e., all) being transmitted from the second radio node.

Example Embodiment C15B. The method of any one of Example Embodiments C1 to C14, wherein receiving the beamforming information comprises receiving the beam forming information in a first message that comprises beamforming information for a subset of a plurality of reference signal beams being transmitted from the second radio node, wherein the first radio node is configured to measure only the subset of the plurality of reference signal beams.

Example Embodiment C16. The method of Example Embodiment C15, further comprising receiving, in a second message, a configuration for measuring a set of reference signal beams.

Example Embodiment C17. The method of any one of Example Embodiments C15 to C16, wherein the first message is received in a SIB message while the first radio node is in an IDLE or INACTIVE state.

Example Embodiment C18. The method of any one of Example Embodiments C15 to C16, wherein the first message is received in an RRC message while the first radio node is in a CONNECTED state.

Example Embodiment C19. The method of any one of Example Embodiments C15 to C16, wherein the first message is received in an DCI.

Example Embodiment C20. The method of any one of Example Embodiments C1 to C19, wherein the beamforming information comprises delta signaling.

Example Embodiment C21. The method of any one of Example Embodiments C1 to C20, further comprising receiving a mapping between a list of reference signal resources indexes and a list of beam spatial-Info parameters, wherein information contained in the k-th beam spatial-Info parameter of corresponds to the k-th reference signal resource.

Example Embodiment C22. The method of any one of Example Embodiments C1 to C21, wherein the beamforming information comprises at least one reference value (i.e., minimum threshold or maximum threshold) for performing a comparison of at least one beam measurement value associated with the at least one reference signal beam.

Example Embodiment C23. The method of any one of Example Embodiments C1 to C22, further comprising transmitting, to the second radio node, a message requesting the beamforming information.

Example Embodiment C24. The method of Example Embodiment C23, wherein the message requesting the beam forming information comprises at least one of: a PRACH request corresponding to a PRACH resource, a RRC Reconfiguration Complete message, a RRC Resume Request message, a RRC Setup Request message, a RRC Resume Complete message, and a RRC Setup Complete message.

Example Embodiment C25. The method of any one of Example Embodiments C1 to C24, wherein the second radio node comprises a multiple-TRP node having M number of TRPs, and wherein the beamforming information comprises M sets of beamforming information, wherein each one of the M sets of beamforming information comprises: at least one parameter related to at least one spatial property of at least one reference signal beam associated with a particular TRP.

Example Embodiment C26. The method of any one of Example Embodiments C1 to C24, wherein the first radio node comprises a multiple-panel node having N number of receive antenna panels, and wherein the beamforming information comprises N sets of beamforming information, wherein each one of the N sets of beamforming information comprises: at least one parameter related to at least one spatial property of at least one reference signal beam to be received by a particular antenna panel.

Example Embodiment C27. The method of any one of Example Embodiments C1 to C26, wherein the first radio node is a user equipment (UE), and the method further comprises: providing user data; and forwarding the user data to a host via the transmission to the network node.

Example Embodiment C28. The method of any one of Example Embodiments C1 to C26, wherein the first radio node is a network node, and the method further comprises: obtaining user data; and forwarding the user data to a host or a user equipment.

Example Embodiment C29. A first radio node comprising processing circuitry configured to perform any of the methods of Example Embodiments C1 to C28.

Example Embodiment C30. A first radio node adapted to perform any of the methods of Example Embodiments C1 to C28.

Example Embodiment C31. A first radio node comprising processing circuitry configured to perform any of the methods of Example Embodiments C1 to C28.

Example Embodiment C32. A first radio node comprising instructions which when executed on a computer perform any of the methods of Example Embodiments C1 to C28.

Example Embodiment C33. A computer program product comprising computer program, the computer program comprising instructions which when executed on a computer perform any of the methods of Example Embodiments C1 to C28.

Example Embodiment C34.A non-transitory computer readable medium storing instructions which when executed by a computer perform any of the methods of Example Embodiments C1 to C28.

### Group D Example Embodiments

Example Embodiment D1. A method by a first radio node for beam pairing prediction, method comprising: transmitting, to a second radio node, beamforming information comprising at least one parameter related to at least one spatial property of at least one reference signal beam.

Example Embodiment D2. The method of Example Embodiment D1, wherein the beamforming information comprises at least one of: a beam configuration, a spatial correlation between two or more reference signal beams, and/or a capability related to beamforming at the second radio node.

Example Embodiment D3. The method of any one of Example Embodiments D1 to D2, wherein the beamforming information is associated with horizontal beamforming, and wherein the spatial information comprises at least one azimuth angle of the at least one reference signal beam.

Example Embodiment D4. The method of any one of Example Embodiments D1 to D2, wherein the beamforming information is associated with vertical beamforming, and wherein the spatial information comprises at least one elevation angle of the at least one reference signal beam.

Example Embodiment D5. The method of any one of Example Embodiments D1 to D2, wherein the beamforming information is associated with horizontal and vertical beamforming, and wherein the spatial information comprises at least one azimuth angle and at least one elevation angle of the at least one reference signal beam.

Example Embodiment D6. The method of any one of Example Embodiments D1 to D5, wherein the beamforming information further comprises at least one of: a main lobe, a beam width, an antenna mechanical down tilt, and an electrical down tilt.

Example Embodiment D7. The method of any one of Example Embodiments D1 to D6, wherein the beamforming information is represented as at least one of: at least one index of a beamforming weight-vector codebook and/or a weighted combination of a predefined weight-vector codebook; at least one index defined by a spatial correlation between the at least one reference signal beam and a specific reference beam; at least one index pointing to a range of beam zenith angle values and/or azimuth angle values; at least one index pointing to a horizontal beam angle and/or a azimuth direction beam angle; at least one value representing a spatial correlation between the at least one reference signal and a specific reference beam; and at least one antenna pattern indicating a number of strongest reference signal beams.

Example Embodiment D8. The method of any one of Example Embodiments D1 to D7, further comprising at least one of: based on the beamforming information, predicting a quality of the at least one reference signal beam; and based on the beamforming information and/or the predicted quality of the at least one reference signal beam, performing at least one action.

Example Embodiment D9. The method of Example Embodiment D8, wherein predicting the quality of the at least one reference signal beam comprises predicting at least one measurement value for the at least one reference signal beam.

Example Embodiment D10. The method of Example Embodiment D9, wherein predicting the at least one measurement value for the at least one reference signal beam comprises at least one of: predicting the at least one measurement value for at least one transmit signal beam; predicting the at least one measurement value for at least one receive signal beam; and predicting the at least one measurement value for a transmit-receive signal beam pair.

Example Embodiment D11. The method of any one of Example Embodiments D8 to D10, wherein performing the at least one action comprises at least one of: including the quality and/or the at least one measurement value predicted for the at least one reference signal beam in a measurement report, initiating a procedure based on at least one of: the beamforming information, the at least one predicted quality of the at least one reference signal beam, and/or the at least one predicted measurement value for the at least one reference signal beam; and/or adjusting at least one parameter of at least one reference signal beam to be transmitted by the first radio node to the second radio node.

Example Embodiment D12A. The method of any one of Example Embodiments D1 to D11, wherein: the first radio node comprises network node; the second radio node comprises a User Equipment (UE), and the at least one reference signal beam comprises at least one transmit reference signal beam associated with the first radio node; and the beamforming information comprises the at least one parameter related to the at least one spatial property of the at least one transmit reference signal beam.

Example Embodiment D12B. The method of Example Embodiment D12A, further comprising receiving, from the second radio node, a message comprising at least one parameter related at least one spatial property of at least one receive reference signal beam used by the second radio node to perform at least one measurement.

Example Embodiment D12C. The method of Example Embodiment D12B, wherein the message comprises at least one capability of the second radio node to report beamforming measurement information.

Example Embodiment D12D. The method of Example Embodiment D12B to D12C, wherein the message is different from a message that includes a beam measurement reporting of at least one measurement value associated with the reference signal beams.

Example Embodiment D13. The method of any one of Example Embodiments D1 to D12D, wherein the at least one reference signal beam comprises: at least one SSB, at least one DMRS, at least one CSI-RS, at least one TRS, and/or at least one SRS.

Example Embodiment D14. The method of any one of Example Embodiments D1 to D13, wherein: the first radio node comprises a user equipment (UE), the second radio node comprises a network node or another user equipment (UE), and the at least one reference signal beam comprises at least one receive reference signal beam associated with the first radio node, and the beamforming information comprises the at least one parameter related to the at least one spatial property of the at least one receive reference signal beam.

Example Embodiment D15A. The method of any one of Example Embodiments D1 to D14, wherein transmitting the beamforming information comprises transmitting the beam forming information in a first message that comprises beamforming information for a plurality of reference signal beams (i.e., all) being transmitted from the first radio node.

Example Embodiment D15B. The method of any one of Example Embodiments D1 to D14, wherein transmitting the beamforming information comprises transmitting the beam forming information in a first message that comprises beamforming information for a subset of a plurality of reference signal beams being transmitted by the first radio node, wherein the second radio node is configured to measure only the subset of the plurality of reference signal beams.

Example Embodiment D16. The method of Example Embodiment D15, further comprising transmitting, to the second radio node, in a second message, a configuration for measuring a set of reference signal beams.

Example Embodiment D17. The method of any one of Example Embodiments D15 to D16, wherein the first message is transmitted in a SIB message while the second radio node is in an IDLE or INACTIVE state.

Example Embodiment D18. The method of any one of Example Embodiments D15 to D16, wherein the first message is transmitted in an RRC message while the second radio node is in a CONNECTED state.

Example Embodiment D19. The method of any one of Example Embodiments D15 to D16, wherein the first message is transmitted in an DC1.

Example Embodiment D20. The method of any one of Example Embodiments D1 to D19, wherein the beamforming information comprises delta signaling.

Example Embodiment D21. The method of any one of Example Embodiments D1 to D20, further comprising transmitting, to the second radio node, a mapping between a list of reference signal resources indexes and a list of beam spatial-Info parameters, wherein information contained in the k-th beam spatial-Info parameter of corresponds to the k-th reference signal resource.

Example Embodiment D22. The method of any one of Example Embodiments D1 to D21, wherein the beamforming information comprises at least one reference value (i.e., minimum threshold or maximum threshold) for performing a comparison of at least one beam measurement value associated with the at least one reference signal beam.

Example Embodiment D23. The method of any one of Example Embodiments D1 to D22, further comprising receiving, from the second radio node, a message requesting the beamforming information.

Example Embodiment D24. The method of Example Embodiment D23, wherein the message requesting the beam forming information comprises at least one of: a PRACH request corresponding to a PRACH resource, a RRC Reconfiguration Complete message, a RRC Resume Request message, a RRC Setup Request message, a RRC Resume Complete message, and a RRC Setup Complete message.

Example Embodiment D25. The method of any one of Example Embodiments D1 to D24, wherein the first radio node comprises a multiple-TRP node having M number of TRPs, and wherein the beamforming information comprises M sets of beamforming information, wherein each one of the M sets of beamforming information comprises: at least one parameter related to at least one spatial property of at least one reference signal beam associated with a particular TRP.

Example Embodiment D26. The method of any one of Example Embodiments D1 to D24, wherein the second radio node comprises a multiple-panel node having N number of receive antenna panels, and wherein the beamforming information comprises N sets of beamforming information, wherein each one of the N sets of beamforming information comprises: at least one parameter related to at least one spatial property of at least one reference signal beam to be received by a particular antenna panel.

Example Embodiment D27. The method of any one of Example Embodiments D1 to D26, wherein the first radio node is a user equipment (UE), and the method further comprises: providing user data; and forwarding the user data to a host via the transmission to the network node.

Example Embodiment D28. The method of any one of Example Embodiments D1 to D26, wherein the first radio node is a network node, and the method further comprises: obtaining user data; and forwarding the user data to a host or a user equipment.

Example Embodiment D29. A first radio node comprising processing circuitry configured to perform any of the methods of Example Embodiments D1 to D28.

Example Embodiment D30. A first radio node adapted to perform any of the methods of Example Embodiments D1 to D28.

Example Embodiment D31. A first radio node comprising processing circuitry configured to perform any of the methods of Example Embodiments D1 to D28.

Example Embodiment D32. A first radio node comprising instructions which when executed on a computer perform any of the methods of Example Embodiments D1 to D28.

Example Embodiment D33. A computer program product comprising computer program, the computer program comprising instructions which when executed on a computer perform any of the methods of Example Embodiments D1 to D28.

Example Embodiment D34. A non-transitory computer readable medium storing instructions which when executed by a computer perform any of the methods of Example Embodiments D1 to D28.

### Group E Example Embodiments

Example Embodiment E1. A user equipment for beam pairing prediction, comprising: processing circuitry configured to perform any of the steps of any of the Group A and C Example Embodiments; and power supply circuitry configured to supply power to the processing circuitry.

Example Embodiment E2. A network node for beam pairing prediction, the network node comprising: processing circuitry configured to perform any of the steps of any of the Group B and D Example Embodiments; power supply circuitry configured to supply power to the processing circuitry.

Example Embodiment E3. A user equipment (UE) for beam pairing prediction, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application. Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a first radio node comprising:
receiving, from a second radio node, beamforming information comprising at least one parameter related to at least one spatial property of at least one reference signal beam.

2. The method of claim 1, wherein prior to receiving the beaming information, the method comprises:
transmitting, to the second radio node, a request for the beamforming information.

3. The method of claim 2, wherein the request for the beam forming information is included in at least one of:
a PRACH request corresponding to a PRACH resource,
a RRC Reconfiguration Complete message,
a RRC Resume Request message,
a RRC Setup Request message,
a RRC Resume Complete message, and
a RRC Setup Complete message.

4. The method of claim 1, wherein the beamforming information related to the at least one spatial property comprises at least one of:
a beam configuration,
a spatial correlation between two or more reference signal beams, and
a capability related to beamforming at the second radio node.

5. The method of claim 1, comprising at least one of:
based on the beamforming information, predicting a quality of the at least one reference signal beam; and
based on the beamforming information and/or the predicted quality of the at least one reference signal beam, performing at least one action.

6. The method of claim 5, wherein:
predicting the quality of the at least one reference signal beam comprises predicting at least one measurement value for the at least one reference signal beam, and
the at least one reference signal beam comprises at least one of:
at least one transmit signal beam,
at least one receive signal beam, and
at least one transmit-receive signal beam pair.

7. The method of claim 5, wherein performing the at least one action comprises at least one of:
including the quality and/or the at least one measurement value predicted for the at least one reference signal beam in a measurement report, and/or
initiating a beam management procedure based on at least one of the beamforming information, the at least one predicted quality of the at least one reference signal beam, and the at least one predicted measurement value for the at least one reference signal beam.

8. The method of claim 1, wherein at least one of:
the beamforming information is associated with horizontal beamforming and the at least one spatial property comprises at least one azimuth angle of the at least one reference signal beam, and
the beamforming information is associated with vertical beamforming and the at least one spatial property comprises at least one elevation angle of the at least one reference signal beam.

9. The method of claim 1, wherein the beamforming information related to the at least one spatial property further comprises at least one of: a main lobe direction, a main lobe beam width, a side lobe direction, a side lobe beam width, an antenna mechanical down tilt, and an electrical down tilt.

10. The method of claim 1, wherein the beamforming information related to the at least one spatial property is represented as at least one index, wherein the at least one index is associated with at least one of:
a beamforming weight-vector codebook and/or a weighted combination of a predefined weight-vector codebook;
a spatial correlation between the at least one reference signal beam and a specific reference beam;
a range of beam zenith angle values and/or azimuth angle values;
a horizontal beam angle and/or a azimuth direction beam angle
at least one value representing a spatial correlation between the at least one reference signal and a specific reference beam; and
at least one antenna pattern indicating a number of strongest reference signal beams.

11. The method of claim 1, wherein:
the first radio node comprises a user equipment, UE,
the second radio node comprises another UE or a network node,
the at least one reference signal beam comprises at least one transmit reference signal beam associated with the second radio node, and
the beamforming information comprising the at least one parameter related to the at least one spatial property is associated with the at least one transmit reference signal beam.

12. The method of claim 11, comprising transmitting, to the second radio node, a first message comprising at least one parameter related at least one spatial property of at least one receive reference signal beam used by the first radio node to perform at least one measurement.

13. The method of claim 12, comprising transmitting, in a second message, a beam measurement reporting of at least one value associated with the reference signal beams, and wherein the first message comprising the at least one parameter is different from the second message that includes the beam measurement reporting.

14. The method of claim 1, wherein:
the first radio node comprises a network node,
the second radio node comprises a user equipment, UE,
the at least one reference signal beam comprises at least one receive reference signal beam associated with the second radio node, and
the beamforming information comprises the at least one parameter related to the at least one spatial property of the at least one receive reference signal beam.

15. The method of claim 1, wherein the at least one reference signal beam comprises at least one of:
at least one Synchronization Signal Block,
at least one Demodulation Reference Signal,
at least one Channel State Information-Reference Signal,
at least one Tracking Reference Signal,
at least one Positioning Reference Signal, and
at least one Sounding Reference Signal.

16. The method of claim 1, wherein receiving the beamforming information comprises:
receiving the beamforming information in a first message that comprises beamforming information for a set of reference signal beams being transmitted from the second radio node, or
receiving the beamforming information in a first message that comprises beamforming information for a subset of a set of reference signal beams being transmitted from the second radio node.

17. The method of claim 16, comprising receiving, in a second message, a configuration for measuring the set or the subset of reference signal beams.

18. The method of claim 16, wherein:
the first message is received in Downlink Control Information,
the first message is received in a System Information Block message while the first radio node is in an IDLE or INACTIVE state, or
the first message is received in a Radio Resource Control message while the first radio node is in a CONNECTED state.

19. The method of claim 1, comprising receiving a mapping between a list of reference signal resources indexes and a list of beam spatial-Info parameters, wherein information contained in the k-th beam spatial-Info parameter of the list of beam spatial-Info parameters corresponds to the k-th reference signal resource index of the list of reference signal resource indexes.

20. The method of claim 1, wherein the beamforming information comprises at least one of a minimum threshold and a maximum threshold for performing a comparison of at least one beam measurement value associated with the at least one reference signal beam.

21. The method of claim 1, wherein at least one of:
the second radio node comprises a multiple-TRP node having M number of TRPs, and wherein the beamforming information comprises M sets of beamforming information, and wherein each one of the M sets of beamforming information comprises at least one parameter related to the at least one spatial property of at least one reference signal beam associated with a particular TRP; and
the first radio node comprises a multiple-panel node having N number of receive antenna panels, and wherein the beamforming information comprises N sets of beamforming information, and wherein each one of the N sets of beamforming information comprises at least one parameter related to the at least one spatial property of at least one reference signal beam to be received by a particular antenna panel.

22. A method by a second radio node comprising:
transmitting, to a first radio node, beamforming information comprising at least one parameter related to at least one spatial property of at least one reference signal beam.

23.-42. (canceled)

43. A first radio node adapted to:
receive, from a second radio node, beamforming information comprising at least one parameter related to at least one spatial property of at least one reference signal beam.

44. (canceled)

45. A second radio node adapted to:
transmit, to a first radio node, beamforming information comprising at least one parameter related to at least one spatial property of at least one reference signal beam.

46. (canceled)
